(19) United States
(12) Patent Application Publication
(10) Pub. No.: US 2025/0055535 A1
(43) Pub. Date: Feb. 13, 2025

(54) SL CSI-RS SIGNALING

(71) Applicant: Samsung Electronics Co., Ltd., Suwon-si (KR)

(72) Inventor: Emad Nader Farag, Flanders, NJ (US)

(21) Appl. No.: 18/786,401

(22) Filed: Jul. 26, 2024

Related U.S. Application Data
(60) Provisional application No. 63/531,742, filed on Aug. 9, 2023.
(60) Provisional application No. 63/532,270, filed on Aug. 11, 2023.

(51) Int. Cl. H04B 7/06; H04W 72/25

(52) U.S. Cl. CPC H04B 7/0626; H04W 72/25

(57) ABSTRACT

Methods and apparatuses for sidelink (SL) channel state information (CSI)-reference signal (RS) signaling. A method of operating a user equipment (UE) includes receiving configuration information for a SL slot, the SL slot including a first part of the SL slot and a second part of the SL slot. The first part includes one or more SL channels. The second part includes one or more SL CSI-RS resources. The method further includes receiving a first SL channel from the one or more SL channels; determining, based on the first SL channel, a first SL CSI-RS resource from the one or more SL CSI-RS resources; and receiving the first SL CSI-RS resource.

### CROSS-REFERENCE TO RELATED AND CLAIM OF PRIORITY

The present application claims priority under 35 U.S.C. § 119(e) to U.S. Provisional Patent Application No. 63/531,742 filed on Aug. 9, 2023 and U.S. Provisional Patent Application No. 63/532,270 filed on Aug. 11, 2023, which are hereby incorporated by reference in their entirety.

### TECHNICAL FIELD

The present disclosure relates generally to wireless communication systems and, more specifically, the present disclosure relates to method and apparatuses for sidelink (SL) channel state information (CSI)-reference signal (RS) signaling.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to SL CSI-RS signaling.

In one embodiment, a user equipment (UE) is provided. The UE includes a transceiver configured to receive configuration information for a sidelink (SL) slot, the SL slot including a first part of the SL slot and a second part of the SL slot. The first part includes one or more SL channels. The second part includes one or more SL channel state information reference signal (CSI-RS) resources. The transceiver is further configured to receive a first SL channel from the one or more SL channels. The UE further includes a processor operably coupled to the transceiver. The processor is configured to determine, based on the first SL channel, a first SL CSI-RS resource from the one or more SL CSI-RS resources. The transceiver is further configured to receive the first SL CSI-RS resource.

In another embodiment, a method of operating a UE is provided. The method includes receiving configuration information for a SL slot, the SL slot including a first part of the SL slot and a second part of the SL slot. The first part includes one or more SL channels. The second part includes one or more SL CSI-RS resources. The method further includes receiving a first SL channel from the one or more SL channels; determining, based on the first SL channel, a first SL CSI-RS resource from the one or more SL CSI-RS resources; and receiving the first SL CSI-RS resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example gNodeB (gNB) according to embodiments of the present disclosure;

FIG. 2B illustrates an example user equipment (UE) according to embodiments of the present disclosure;

FIGS. 3A and 3B illustrate an example of a wireless transmit and receive paths according to embodiments of the present disclosure;

FIG. 4 illustrates a flowchart of an example process for a layer-2 link establishment for unicast mode of vehicle to everything (V2X) communication over protocol layer convergence for 5G new radio (PC5) reference point according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example medium access control (MAC) control element (CE) signaling according to embodiments of the present disclosure;

FIG. 8 illustrates an example of SL signaling in a wireless communication system according to embodiments of the present disclosure;

FIG. 9 illustrates examples of structures for SL CSI-RS transmissions according to embodiments of the present disclosure;

FIG. 10 illustrates additional examples of structures for SL CSI-RS transmissions according to embodiments of the present disclosure;

FIG. 11 illustrates examples of CSI-RS occasions in a SL slot according to embodiments of the present disclosure;

FIG. 12 illustrates examples of structures for CSI-RS transmissions according to embodiments of the present disclosure;

FIG. 13 illustrates examples of structures for CSI-RS transmissions according to embodiments of the present disclosure;

FIG. 14 illustrates examples of CSI-RS occasions in a SL slot according to embodiments of the present disclosure;

FIG. 15 illustrates an example for CSI-RS occasions where a same beam or spatial domain filter or spatial relation is used for the control part;

FIG. 16 illustrates an example for CSI-RS occasions where a different beam or spatial domain filter or spatial relation is used for the control part;

FIG. 17 illustrates examples of CSI-RS occasions in a SL slot according to embodiments of the present disclosure;

FIG. 18 illustrates examples of CSI-RS occasions in a SL slot according to embodiments of the present disclosure;

FIG. 19 illustrates examples structures for of CSI-RS occasions in a SL slot according to embodiments of the present disclosure;

FIG. 20A illustrates examples of allocations of SL CSI-RS in a slot according to embodiments of the present disclosure;

FIG. 20B illustrates an example of physical sidelink control channel (PSCCH) to SL CSI-RS occasion mappings according to embodiments of the present disclosure;

FIG. 21 illustrates an additional example of PSCCH to SL CSI-RS occasion mappings according to embodiments of the present disclosure;

FIGS. 22-23 illustrate examples of frequency regions for SL CSI-RS transmission in a SL slot according to embodiments of the present disclosure; and

FIG. 24 illustrates a flowchart of an example UE procedure for SL CSI-RS signaling according to embodiments of the present disclosure.

### DETAILED DESCRIPTION

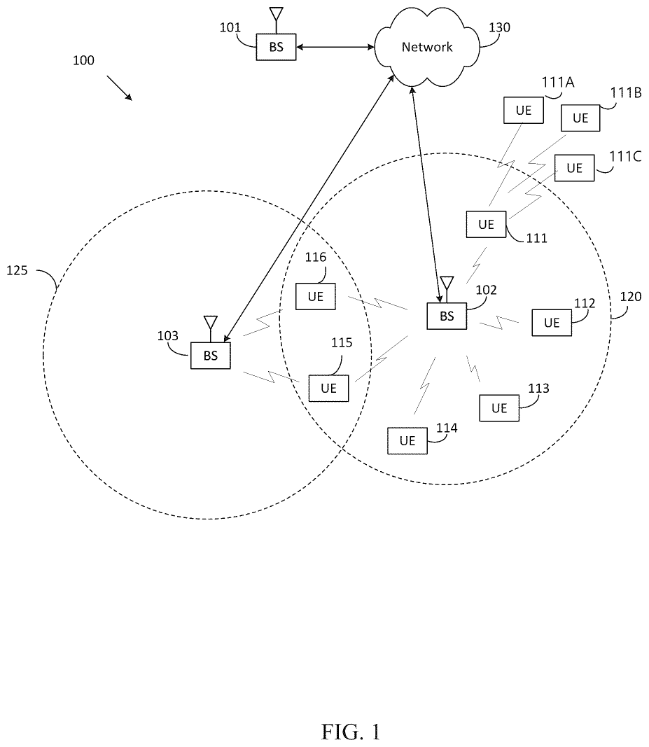

FIGS. 1-24, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to the deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.5.0, “NR; Physical channels and modulation;” [2] 3GPP TS 38.212 v17.5.0, “NR; Multiplexing and Channel coding;” [3] 3GPP TS 38.213 v17.6.0, “NR; Physical Layer Procedures for Control;” [4] 3GPP TS 38.214 v17.6.0, “NR; Physical Layer Procedures for Data;” [5] 3GPP TS 38.321 v17.5.0, “NR; Medium Access Control (MAC) protocol specification;” [6] 3GPP TS 38.331 v17.5.0, “NR; Radio Resource Control (RRC) Protocol Specification;” [7] 3GPP TS 36.213 v17.5.0, “Evolved Universal Terrestrial Radio Access (E-UTRA); Physical layer procedures;” and [8] RP-213678, “WID on NR sidelink evolution.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for SL CSI-RS signaling.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

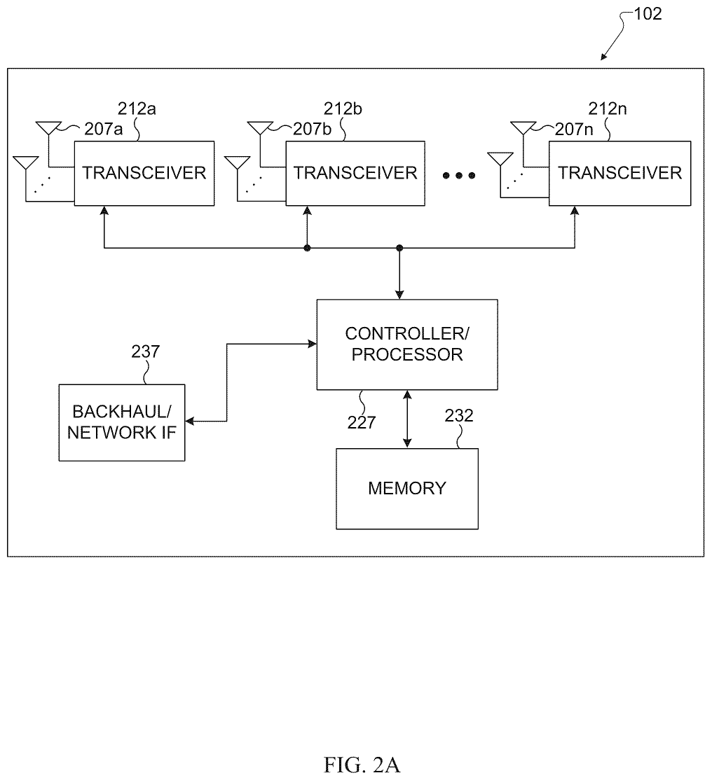

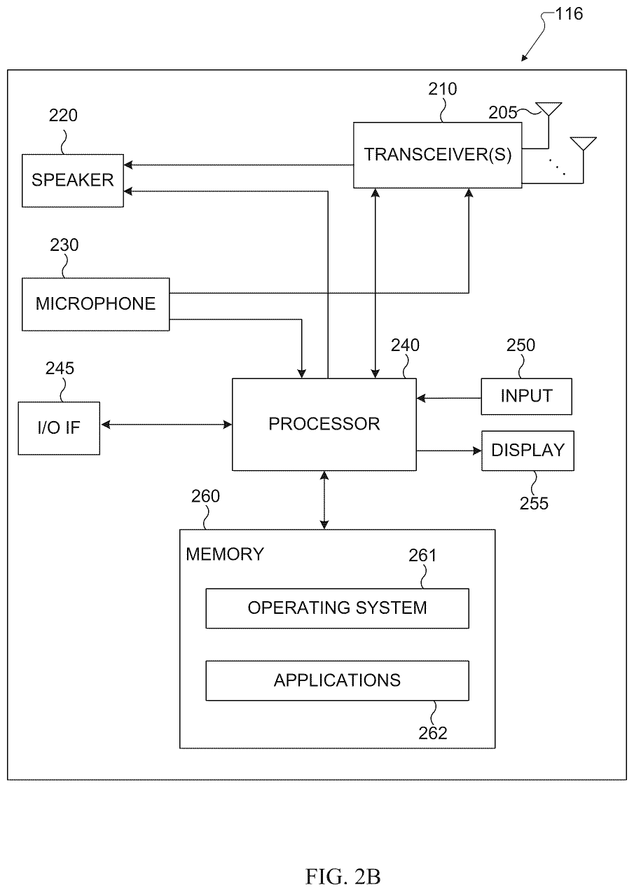

FIG. 2A illustrates an example gNB 102 according to embodiments of the present disclosure. The embodiment of the gNB 102 illustrated in FIG. 2A is for illustration only, and the gNBs 101 and 103 of FIG. 1 could have the same or similar configuration. However, gNBs come in a wide variety of configurations, and FIG. 2A does not limit the scope of this disclosure to any particular implementation of a gNB.

As shown in FIG. 2A, the gNB 102 includes multiple antennas 207a-207n, multiple transceivers 212a-212n, a controller/processor 227, a memory 232, and a backhaul or network interface 237.

The transceivers 212a-212n receive, from the antennas 207a-207n, incoming radio frequency (RF) signals, such as signals transmitted by UEs in the wireless network 100. The transceivers 212a-212n down-convert the incoming RF signals to generate IF or baseband signals. The IF or baseband signals are processed by receive (RX) processing circuitry in the transceivers 212a-212n and/or controller/processor 227, which generates processed baseband signals by filtering, decoding, and/or digitizing the baseband or IF signals. The controller/processor 227 may further process the baseband signals.

Transmit (TX) processing circuitry in the transceivers 212a-212n and/or controller/processor 227 receives analog or digital data (such as voice data, web data, e-mail, or interactive video game data) from the controller/processor 227. The TX processing circuitry encodes, multiplexes, and/or digitizes the outgoing baseband data to generate processed baseband or IF signals. The transceivers 212a-212n up-converts the baseband or IF signals to RF signals that are transmitted via the antennas 207a-207n.

The controller/processor 227 can include one or more processors or other processing devices that control the overall operation of the gNB 102. For example, the controller/processor 227 could control the reception of uplink (UL) channels and/or signals and the transmission of downlink (DL) channels and/or signals by the transceivers 212a-212n in accordance with well-known principles. The controller/processor 227 could support additional functions as well, such as more advanced wireless communication functions. For instance, the controller/processor 227 could support beam forming or directional routing operations in which outgoing/incoming signals from/to multiple antennas 207a-207n are weighted differently to effectively steer the outgoing signals in a desired direction. Any of a wide variety of other functions could be supported in the gNB 102 by the controller/processor 227.

The controller/processor 227 is also capable of executing programs and other processes resident in the memory 232, such as to support SL CSI-RS signaling. The controller/processor 227 can move data into or out of the memory 232 as required by an executing process.

The controller/processor 227 is also coupled to the backhaul or network interface 237. The backhaul or network interface 237 allows the gNB 102 to communicate with other devices or systems over a backhaul connection or over a network. The interface 237 could support communications over any suitable wired or wireless connection(s). For example, when the gNB 102 is implemented as part of a cellular communication system (such as one supporting 5G/NR, LTE, or LTE-A), the interface 237 could allow the gNB 102 to communicate with other gNBs over a wired or wireless backhaul connection. When the gNB 102 is implemented as an access point, the interface 237 could allow the gNB 102 to communicate over a wired or wireless local area network or over a wired or wireless connection to a larger network (such as the Internet). The interface 237 includes any suitable structure supporting communications over a wired or wireless connection, such as an Ethernet or transceiver.

The memory 232 is coupled to the controller/processor 227. Part of the memory 232 could include a RAM, and another part of the memory 232 could include a Flash memory or other ROM.

Although FIG. 2A illustrates one example of gNB 102, various changes may be made to FIG. 2A. For example, the gNB 102 could include any number of each component shown in FIG. 2A. Also, various components in FIG. 2A could be combined, further subdivided, or omitted and additional components could be added according to particular needs.

FIG. 2B illustrates an example UE 116 according to embodiments of the present disclosure. The embodiment of the UE 116 illustrated in FIG. 2B is for illustration only, and the UEs 111-115 of FIG. 1 could have the same or similar configuration. Additionally, where the term “UE” is used herein, the UE may be any of UE's 111-116 in FIG. 1 and this UE may have the same or similar configuration as described with and illustrated respect to UE 116 in FIG. 2B. However, UEs come in a wide variety of configurations, and FIG. 2B does not limit the scope of this disclosure to any particular implementation of a UE.

As shown in FIG. 2B, the UE 116 includes antenna(s) 205, a transceiver(s) 210, and a microphone 220. The UE 116 also includes a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal transmitted by a gNB of the wireless network 100 or by other UEs (e.g., one or more of UEs 111-115) on a SL channel. The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors or other processing devices and execute the OS 261 stored in the memory 260 in order to control the overall operation of the UE 116. For example, the processor 240 could control the reception of DL channels and/or signals or SL channels and/or signals and the transmission of UL channels and/or signals or SL channels and/or signals by the transceiver(s) 210 in accordance with well-known principles. In some embodiments, the processor 240 includes at least one microprocessor or microcontroller.

The processor 240 is also capable of executing other processes and programs resident in the memory 260. For example, the processor 240 may execute processes for utilizing and supporting SL CSI-RS signaling as described in embodiments of the present disclosure. The processor 240 can move data into or out of the memory 260 as required by an executing process. In some embodiments, the processor 240 is configured to execute the applications 262 based on the OS 261 or in response to signals received from gNBs or another SL UE or an operator. The processor 240 is also coupled to the I/O interface 245, which provides the UE 116 with the ability to connect to other devices, such as laptop computers and handheld computers. The I/O interface 245 is the communication path between these accessories and the processor 240.

The processor 240 is also coupled to the input 250, which includes, for example, a touchscreen, keypad, etc., and the display 255. The operator of the UE 116 can use the input 250 to enter data into the UE 116. The display 255 may be a liquid crystal display, light emitting diode display, or other display capable of rendering text and/or at least limited graphics, such as from web sites.

The memory 260 is coupled to the processor 240. Part of the memory 260 could include a random-access memory (RAM), and another part of the memory 260 could include a Flash memory or other read-only memory (ROM).

Although FIG. 2B illustrates one example of UE 116, various changes may be made to FIG. 2B. For example, various components in FIG. 2B could be combined, further subdivided, or omitted and additional components could be added according to particular needs. As a particular example, the processor 240 could be divided into multiple processors, such as one or more central processing units (CPUs) and one or more graphics processing units (GPUs). In another example, the transceiver(s) 210 may include any number of transceivers and signal processing chains and may be connected to any number of antennas. Also, while FIG. 2B illustrates the UE 116 configured as a mobile telephone or smartphone, UEs could be configured to operate as other types of mobile or stationary devices.

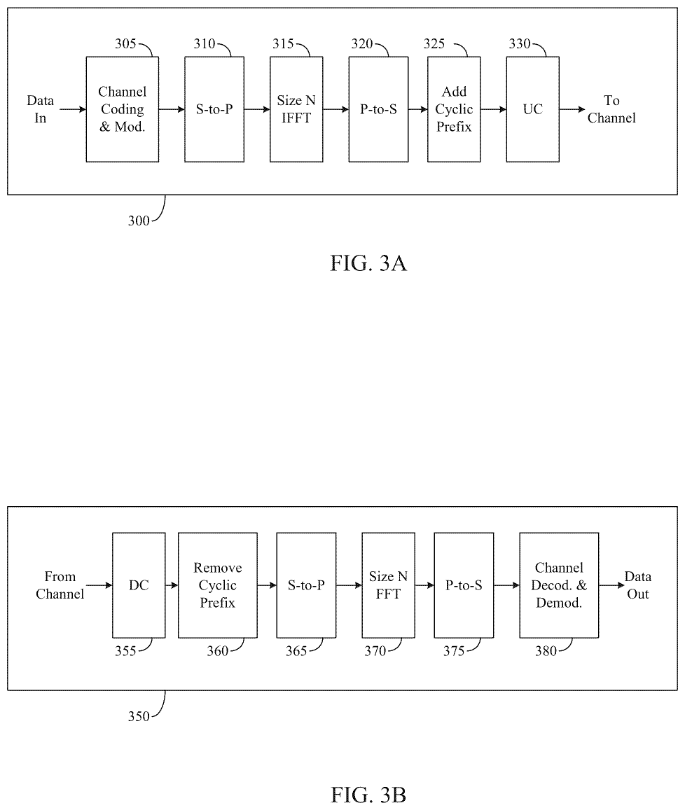

FIG. 3A and FIG. 3B illustrate an example of wireless transmit and receive paths 300 and 350, respectively, according to embodiments of the present disclosure. For example, a transmit path 300 may be described as being implemented in a gNB (such as gNB 102), while a receive path 350 may be described as being implemented in a UE (such as UE 116). However, it will be understood that the receive path 350 can be implemented in a gNB and that the transmit path 300 can be implemented in a UE. It may also be understood that the receive path 350 can be implemented in a first UE and that the transmit path 300 can be implemented in a second UE to support SL communications or SL positioning. In some embodiments, the transmit path 300 and the receive path 350 can be configured to support SL CSI-RS signaling as described in embodiments of the present disclosure.

As illustrated in FIG. 3A, the transmit path 300 includes a channel coding and modulation block 305, a serial-to-parallel (S-to-P) block 310, a size N Inverse Fast Fourier Transform (IFFT) block 315, a parallel-to-serial (P-to-S) block 320, an add cyclic prefix block 325, and an up-converter (UC) 330. The receive path 350 includes a down-converter (DC) 355, a remove cyclic prefix block 360, a S-to-P block 365, a size N Fast Fourier Transform (FFT) block 370, a parallel-to-serial (P-to-S) block 375, and a channel decoding and demodulation block 380.

In the transmit path 300, the channel coding and modulation block 305 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 310 converts (such as de-multiplexes) the serial modulated symbols to parallel data in order to generate N parallel symbol streams, where N is the IFFT/FFT size used in the gNB 102 and the UE (e.g., UEs 111-116). The size N IFFT block 315 performs an IFFT operation on the N parallel symbol streams to generate time-domain output signals. The parallel-to-serial block 320 converts (such as multiplexes) the parallel time-domain output symbols from the size N IFFT block 315 in order to generate a serial time-domain signal. The add cyclic prefix block 325 inserts a cyclic prefix to the time-domain signal. The up-converter 330 modulates (such as up-converts) the output of the add cyclic prefix block 325 to a RF frequency for transmission via a wireless channel. The signal may also be filtered at a baseband before conversion to the RF frequency.

As illustrated in FIG. 3B, the down-converter 355 down-converts the received signal to a baseband frequency, and the remove cyclic prefix block 360 removes the cyclic prefix to generate a serial time-domain baseband signal. The serial-to-parallel block 365 converts the time-domain baseband signal to parallel time-domain signals. The size N FFT block 370 performs an FFT algorithm to generate N parallel frequency-domain signals. The (P-to-S) block 375 converts the parallel frequency-domain signals to a sequence of modulated data symbols. The channel decoding and demodulation block 380 demodulates and decodes the modulated symbols to recover the original input data stream.

Each of the gNBs 101-103 may implement a transmit path 300 that is analogous to transmitting in the downlink to UEs 111-116 and may implement a receive path 350 that is analogous to receiving in the uplink from UEs 111-116. Similarly, each of UEs 111-116 may implement a transmit path 300 for transmitting in the uplink to gNBs 101-103, and/or for transmitting in the sidelink to another UE and may implement a receive path 350 for receiving in the downlink from gNBs 101-103 and/or for receiving in the sidelink for another UE.

Each of the components in FIGS. 3A and 3B can be implemented using only hardware or using a combination of hardware and software/firmware. As a particular example, at least some of the components in FIGS. 3A and 3B may be implemented in software, while other components may be implemented by configurable hardware or a mixture of software and configurable hardware. For instance, the FFT block 370 and the IFFT block 315 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 3, or the like) for DFT and IDFT functions, while the value of the variable N may be any integer number that is a power of two (such as 1, 2, 3, 8, 16, or the like) for FFT and IFFT functions.

Although FIGS. 3A and 3B illustrate examples of wireless transmit and receive paths 300 and 350, respectively, various changes may be made to FIGS. 3A and 3B. For example, various components in FIGS. 3A and 3B can be combined, further subdivided, or omitted and additional components can be added according to particular needs. Also, FIGS. 3A and 3B are meant to illustrate examples of the types of transmit and receive paths that can be used in a wireless network. Any other suitable architectures can be used to support wireless communications in a wireless network.

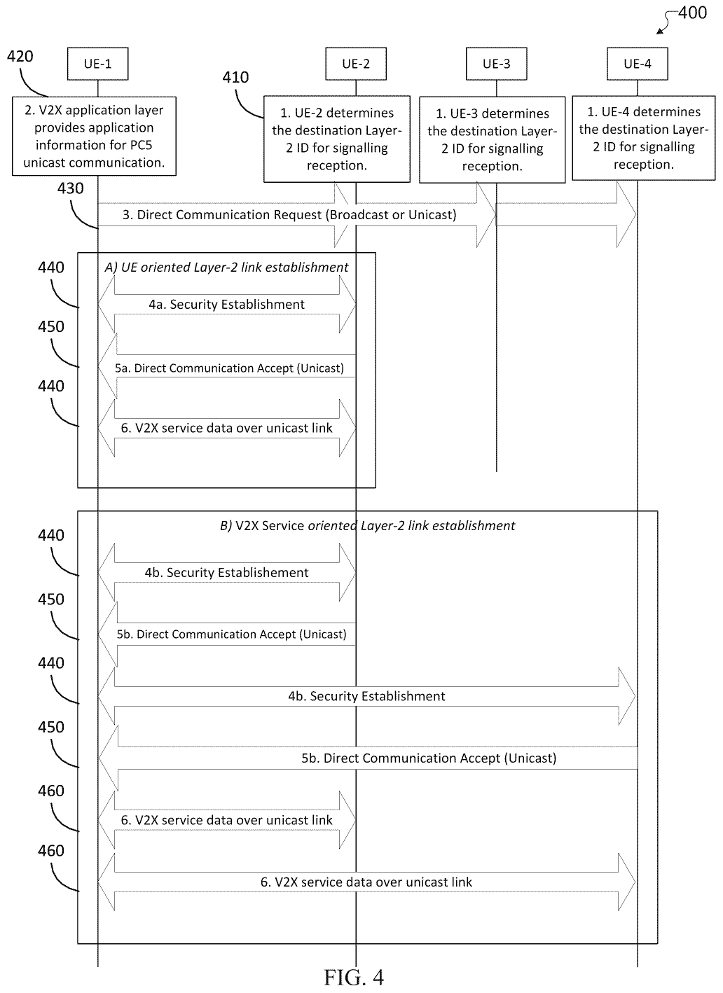

FIG. 4 illustrates a flowchart of an example process 400 for a layer-2 link establishment for unicast mode of V2X communication over PC5 reference point according to embodiments of the present disclosure. For example, process 400 can be performed by multiple of the UEs 111-116 of FIG. 1 to perform SL communications. This example is for illustration only and other embodiments can be used without departing from the scope of the present disclosure.

Process 400 begins in step 410, the UE(s) determine the destination Layer-2 ID for signaling reception of PC5 unicast link establishment. This is determined as specified in clause 5.4.1.4 of TS 23.387. The destination Layer-2 ID is configured with the UE(s) as specified in clause 5.1.2.1 of TS 23.387. In step 420, the V2X application layer in UE-1 provides application information for PC5 unicast communicating. In step 430, UE-1 sends a Direct Communication Request (DCR) to initiate the unicast layer-2 link establishment procedure and sends the DCR message via PC5 broadcast or unicast using the source Layer-2 ID and destination Layer-2 ID. In step 440, the target UE, or the UEs that are interested in using the announced V2X service type(s) over a PC5 unicast link with UE-1, responds which establishes the security with UE-1. In step 450, the target UE(s) that has successfully established security with UE-1 sends a direct communication accept message to UE-1. In step 460, V2X service data is transmitted over the established unicast link.

With reference to FIG. 4 (FIG. 4.3.3.1-1 of TS 23.387) the Layer-2 link establishment procedure for unicast mode of V2X communication over PC5 reference point is shown.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications or SL positioning. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL Broadcast channel (PSBCH) conveying system information to assist in SL synchronization. SL signals include demodulation reference signals (DM-RSs) that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization and SL position reference signal (SL PRS) for SL positioning measurements. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a downlink control information (DCI) format (e.g., DCI Format 3_0) transmitted from the gNB 102 on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE:
1. HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.
2. HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′MAX-1}^{SL}} and can be configured, for example, at least using a bitmap, where T′_{MAX} is the number of SL slots in a resource pool, e.g., within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission R_{x,y} is defined as a set of L_{subCH} contiguous subchannels x+i, where i=0, 1, . . . , L_{subCH}−1 in slot t_{y}^{SL}·T₁ is determined by the UE such that, 0≤T₁≤T_{proc,1}^{SL}, where T_{proc,1}^{SL} is a PSSCH processing time for example as defined in TS 38.214 [REF4] Table 8.1.4-2. T₂ is determined by the UE such that T_{2 min}≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as follows:
1. Let set of slots that may belong to a resource be denoted by {t₀^{SL}, t₁^{SL}, t₂^{SL}, . . . , t_{T}_{_{MAX}}₋₁^{SL}}, where 0≤tᵢ^{SL}<10240×2^{μ}, and 0≤i<Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=3 for a 120 kHz sub-carrier spacing. The slot index is relative to slot #0 of SFN #0 (system frame number 0) of the serving cell, or DFN #0 (direct frame number 0). The set of slots includes all slots except:
   a. N_{S-SSB} slots that are configured for SL synchronization signal/physical SL broadcast channels (S-SS/PSBCH) Block (S-SSB).
   b. N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   c. N_{reserved} reserved slots. Reserved slots are determined such that the slots in the set {t₀^{SL}, t₁^{SL}, t₂^{SL}, . . . , t_{T}_{_{MAX}}₋₁} is a multiple of the bitmap length (L_{bitmap}), where the bitmap (b₀, b₁, . . . , b_{L}_{_{bitmap}}₋₁) is configured by higher layers. The reserved slots are determined as follows:
      i. Let {l₀, l₁, . . . , l₂_{^{μ}}_{×10240-N}_{_{S-SSB}}_{-N}_{_{nonSL}}₋₁} be the set of slots in range 0 . . . 2^{μ}×10240−1, excluding S-SSB slots and non-SL slots. The slots are arranged in ascending order of the slot index.
      ii. The number of reserved slots is given by: N_{reserved}=(2^{μ}×10240−N_{S-SSB}−N_{nonsL}) mod L_{bitmap}.
      iii. The reserved slots lᵣ are given by:

$$r = ⌊ \frac{m \cdot ( {2}^{μ} \times 10240 - {N}_{S - SSB} - {N}_{nonSL} )}{{N}_{reserved}} ⌋ ,$$

where, m=0, 1, . . . , N_{reserved}−1. Tₘₐₓ is given by: Tₘₐₓ=2^{μ}×10240−N_{S-SSB}−N_{nonsL}−N_{reserved}.
2. The slots are arranged in ascending order of slot index.
3. The set of slots belonging to the SL resource pool, {t′₀^{SL}, t′₁^{SL}, t′₂^{SL}, . . . , t′_{T′}_{_{MAX}}₋₁^{SL}}, are determined as follows:
   a. Each resource pool has a corresponding bitmap (b₀, b₁, . . . , b_{L}_{_{bitmap}}₋₁) of length L_{bitmap}.
   b. A slot tₖ^{SL} belongs to the SL resource pool if b_{k mod L}_{_{bitmap}}=1
   c. The remaining slots are indexed successively staring from 0, 1, . . . T′_{MAX}−1, where T′_{MAX} is the number of remaining slots in the set.

Slots can be numbered (indexed) as physical slots or logical slots, wherein physical slots include all slots numbered sequential, while logical slots include only slots that are allocated to sidelink resource pool as described herein numbered sequentially. The conversion from a physical duration, Pᵣₛᵥₚ, in milli-second to logical slots, P′ᵣₛᵥₚ, is given by

$${P}_{rsvp}^{′} = ⌈ \frac{T {′}_{max}}{10240 ms} \times {P}_{rsvp} ⌉$$

(see section 8.1.7 of 38.214 [4]).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤TP_{proc,1}^{SL}, where T_{proc,1}^{SL} is a PSSCH processing time for example as defined in 3GPP standard specification TS 38.214 [REF4] Table 8.1.4-2. T₂ is determined by the UE such that T₂ₘᵢₙ≤T₂≤Remaining Packet Delay Budget as long as T₂ₘᵢₙ≤Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure:
1. The first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL reference signal received power (RSRP) that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH demodulation reference signal (DMRS) or PSSCH DMRS. Sensing is performed over slots where the UE does not transmit SL. The resources excluded are based on reserved transmissions or semi-persistent transmissions that can collide with the excluded resources or any of reserved or semi-persistent transmissions. The identified candidate resources after resource exclusion are provided to higher layers.
2. The second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification, TS 38.214 [REF4] Table 8.1.4-1. To determine a candidate single-slot resource set to report to higher layers, a UE excludes (e.g., resource exclusion) from the set of available single-slot resources for SL transmission within a resource pool and within a resource selection window, the following:
1. Single slot resource R_{x,y}, such that for any slot t′ₘ^{SL} not monitored within the sensing window with a hypothetical received SCI Format 1-0, with a “Resource reservation period” set to any periodicity value allowed by a higher layer parameter reservationPeriodAllowed, and indicating all sub-channels of the resource pool in this slot, satisfies condition 2.2. herein.
2. Single slot resource R_{x,y}, such that for any received SCI within the sensing window:
   a. The associated L1-RSRP measurement is above a (pre-)configured SL-RSRP threshold, where the SL-RSRP threshold depends on the priority indicated in the received SCI and that of the SL transmission for which resources are being selected.
   b. (Condition 2.2) The received SCI in slot t′ₘ^{SL}, or if “Resource reservation field” is present in the received SCI the same SCI is assumed to be received in slot t′_{m+q×P′}_{_{rsvp_Rx}}^{SL}, indicates a set of resource blocks that overlaps R_{x,y+j×P′}_{_{rsvp_Tx}}.
      Where,

| i. | q = 1,2, ... , Q, where, | |
|---|---|---|
| | • | $If {P}_{rsvp \_ RX} \leq {T}_{scal} and {n}^{′} - m < {P}_{rsvp \_ RX}^{′} \to Q = ⌈ \frac{{T}_{scal}}{{P}_{rsvp \_ RX}} ⌉ \cdot {T}_{scal}$ |
| | | is T₂ in units of milli-seconds. |
| | • | Else Q = 1 |
| | • | If n belongs to (t′₀^{SL}, t′₁^{SL}, ... , t′_{T′max-1}^{SL}), n′ = n, else n′ is the |
| | | first slot after slot n belonging to set (t′₀^{S}, t′₁^{SL}, ... , t′_{T′max-1}^{SL}). |

| | |
|---|---|
| ii. | j = 0, 1, ... , Cᵣₑₛₑₗ − 1 |
| iii. | Pᵣₛᵥₚ_RX is the indicated resource reservation period in the received |
| | SCI in physical slots, and P′ᵣₛᵥₚ_Rx is that value converted to |
| | logical slots. |
| iv. | P′ᵣₛᵥₚ_Tx is the resource reservation period of the SL transmissions |
| | for which resources are being reserved in logical slots. |

3. If the candidate resources are less than a (pre-)configured percentage given by higher layer parameter sl_TxPrecentageList(prio_{TX}) that depends on the priority of the SL transmission prio_{TX}, such as 20% of the total available resources within the resource selection window, the (pre-)configured SL-RSRP thresholds are increased by a predetermined amount, such as 3 dB.

NR sidelink introduced two new procedures for mode 2 resource allocation: re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃. The re-evaluation check includes:
1. Performing the first step of the SL resource selection procedure as defined in the 3GPP specifications [i.e., 38.214 clause 8.1.4] which involves identifying a candidate (available) sidelink resource set in a resource selection window as previously described.
2. If the pre-selected resource is available in the candidate sidelink resource set, the resource is used/signaled for sidelink transmission.
3. Else, the pre-selected resource is not available in the candidate sidelink resource set, a new sidelink resource is re-selected from the candidate sidelink resource set.

Pre-emption check occurs when a UE checks the availability of pre-selected SL resources that have been previously signaled and reserved in an SCI Format and, if needed, re-selects new SL resources. For a pre-selected and reserved resource to be signaled in slot m, the UE performs a pre-emption check at least in slot m−T₃. When pre-emption check is enabled by higher layers, pre-emption check includes:
1. Performing the first step of the SL resource selection procedure as defined in the 3GPP specifications [i.e., 38.214 clause 8.1.4], which involves identifying candidate (available) sidelink resource set in a resource selection window as previously described.
2. If the pre-selected and reserved resource is available in the candidate sidelink resource set, the resource is used/signaled for sidelink transmission.
3. Else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.
   If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority.
   Else, the resource is used/signaled for sidelink transmission.

As described herein, the monitoring procedure for resource (re)selection during the sensing window requires reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink. The sensing procedure mentioned herein is referred to a full sensing.

3GPP Release 16 is the first NR release to include sidelink through work item “5G V2X with NR sidelink”, the mechanisms introduced focused mainly on vehicle-to-everything (V2X) and can be used for public safety when the service requirement can be met. Release 17 extends sidelink support to more use cases through work item “NR Sidelink enhancement” (RP-201385). The objectives of Rel-17 SL include: (1) Resource allocation enhancements that reduce power consumption and (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList and, if not configured, Pᵣₑₛₑᵣᵥₑ includes all periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-)configured, and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. UE-A provides information to UE-B, and UE-B uses the provided information for its resource allocation mode 2 (re-)selection procedure. IUC is designed to address issues with distributed resource allocation such as: (1) Hidden node problem, where a UE-B is transmitting to a UE-A and UE-B can't sense or detect transmissions from a UE-C that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting in, UE-A will miss the transmission from UE-B as UE-A cannot receive and transmit in the same slot.

There are two schemes for inter-UE co-ordination:
1. In one example, in scheme 1, a UE-A can provide to another UE-B indications of resources that are preferred to be included in UE-B's (re-)selected resources, or non-preferred resources to be excluded for UE-B's (re-)selected resources. When given preferred resources, UE-B may use only those resources for its resource (re-)selection, or UE-B may combine them with resources identified by its own sensing procedure, e.g., by finding the intersection of the two sets of resources, for its resource (re-)selection. When given non-preferred resources, UE-B may exclude these resources from resources identified by its own sensing procedure for its resource (re-)selection.
   Transmissions of co-ordination information (e.g., IUC messages) transmitted by UE-A to UE-B, and co-ordination information requests (e.g., IUC requests) transmitted by UE-A to UE-B, are transmitted in a MAC-CE message and may also, if supported by the UEs, be transmitted in a 2^{nd}-stage SCI Format (SCI Format 2-C). The benefit of using the 2nd stage SCI is to reduce latency. IUC messages from UE-A to UE-B can be transmitted standalone or can be combined with other SL data. Coordination information (IUC messages) can be in response to a request from UE-B, or due to a condition at UE-A. An IUC request is unicast from UE-B to UE-A, in response UE-A transmits an IUC message in unicast mode to UE-B. An IUC message transmitted as a result of an internal condition at UE-A can be unicast to UE-B, when the IUC message includes preferred resources, or can be unicast, groupcast or broadcast to UE-B when the IUC message includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where UE-A cannot receive data from a UE-B in the same slot UE-A is transmitting.
2. In another example, in scheme 2, a UE-A can provide to another UE-B an indication that resources reserved for UE-B's transmission, whether or not UE-A is the destination UE of these resources, are subject to conflict with a transmission from another UE. UE-A determines the conflicting resources based on the priority and RSRP of the transmissions involved in the conflict. UE-A can also determine a presence of a conflict due to the half-duplex problem, where UE-A cannot receive a reserved resource from UE-B at the same time UE-A is transmitting. When UE-B receives a conflict indication for a reserved resource, UE-B can re-select new resources to replace them.
   The conflict information from UE-A is transmitted in a PSFCH channel separately (pre-)configured from the PSFCH of the SL-HARQ operation. The timing of the PSFCH channel carrying conflict information can be based on the SCI indicating reserved resource or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which UE-B might not be able to determine on its own due to hidden nodes, exposed nodes, persistent collisions, etc.

Release 18 enhances further evolution of the NR SL air interface for operation in unlicensed bands, beam-based operation in FR2, SL carrier aggregation and co-channel co-existence between LTE SL and NR SL.

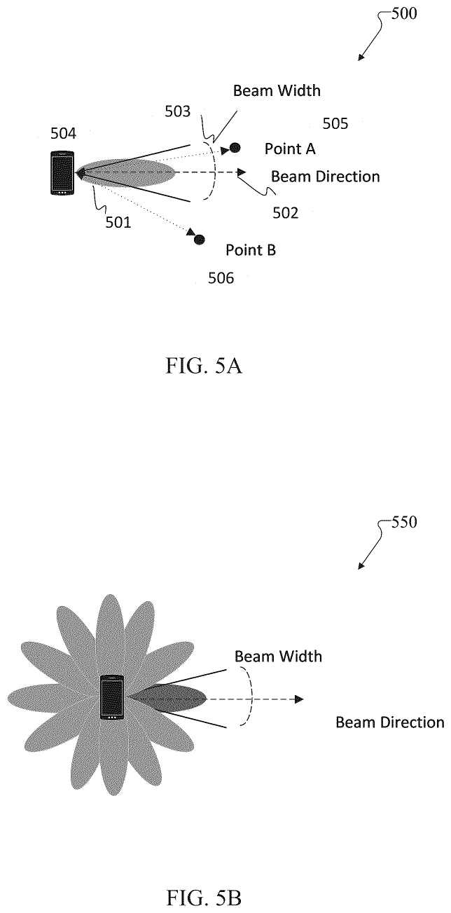

FIG. 5A illustrates an example of beam directions 500 in a wireless communication system according to embodiments of the present disclosure. For example, the beam directions 500 can be utilized by the UE 116 of FIG. 2B. This example is for illustration only and other embodiments can be used without departing from the scope of the present disclosure.

As illustrated in FIG. 5A, in a wireless system 500, a beam 501 for a device 504 can be characterized by a beam direction 502 and a beam width 503. For example, the device 504 (or UE) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be performed by UE 116 of FIG. 2B. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

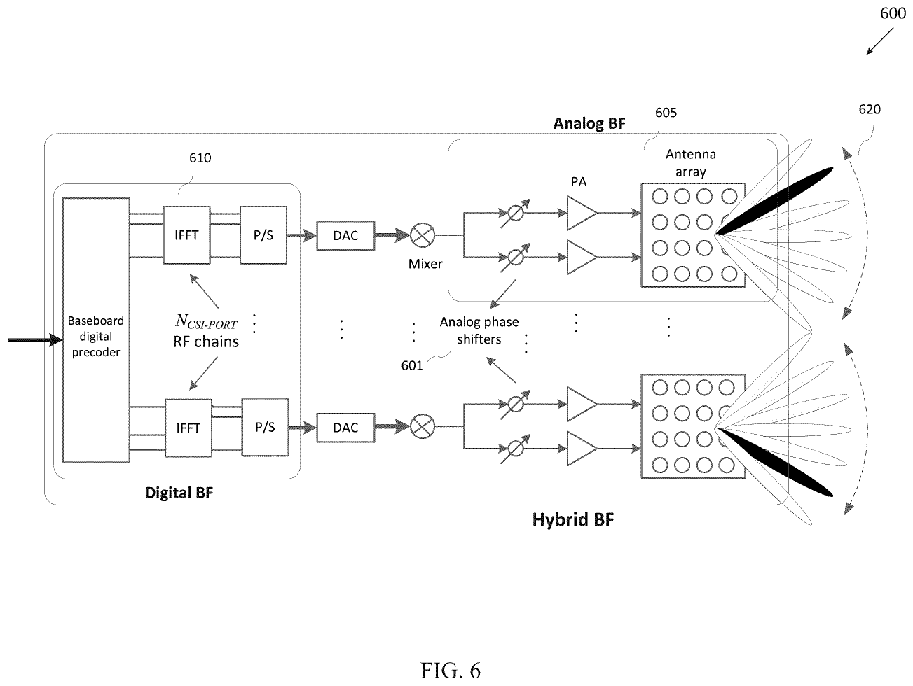

FIG. 6 illustrates an example of a transmitter structure 600 for beamforming according to embodiments of the present disclosure. In certain embodiments, one or more of gNB 102 or UE includes the transmitter structure 600. For example, one or more of antenna 205 and its associated systems or antenna 207a-207n and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting”, respectively), and receiving a DL or UL or SL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

On the Uu interface a beam is determined by either of:
A transmission configuration indication (TCI) state, which establishes a quasi-colocation (QCL) relationship between a source reference signal (e.g., SSB and/or CSI-RS) and a target reference signal.
A spatial relation information that establishes an association to a source reference signal, such as SSB or CSI-RS or sounding reference signal (SRS).

In either case, the ID of the source reference signal and/or TCI state and/or spatial relation identifies the beam.

Terminology such as TCI, TCI states, SpatialRelationlnfo, target RS, reference RS, and other terms is used for illustrative purposes and is therefore not normative. Other terms that refer to same functions can also be used.

Rel-17 introduced the unified TCI framework, where a unified or master or main or indicated TCI state is signaled or indicated to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is a DL or a Joint TCI state of UE-dedicated reception on physical downlink shared channel (PDSCH)/physical downlink control channel (PDCCH) and the CSI-RS applying the indicated TCI state and/or an UL or a Joint TCI state for dynamic-grant/configured-grant based physical uplink shared channel (PUSCH), physical uplink control channel (PUCCH), and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE-dedicated channels can be received and/or transmitted using a TCI state associated with a cell having a PCI different from the PCI of the serving cell. While the common channels can be received and/or transmitted using a TCI state associated with the serving cell (e.g., not associated with a cell having a PCI different from the PCI of the serving cell). Common channels can include:
Channels carrying system information (e.g., SIB) with a DL assignment carried by a DCI in PDCCH having a CRC scrambled by system information (SI)-RNTI and transmitted in Type0-PDCCH common search space (CSS) set.
Channels carrying other system information with a DL assignment carried by a DCI in PDCCH having a CRC scrambled by SI-RNTI and transmitted in Type0A-PDCCH CSS set.
Channels carrying paging or short messages with a DL assignment carried by a DCI in PDCCH having a CRC scrambled by paging radio network temporary identifier (P-RNTI) and transmitted in Type2-PDCCH CSS set.
Channels carrying random access channel (RACH) related channels with a DL assignment or UL grant carried by a DCI in PDCCH having a CRC scrambled by random access (RA)-RNTI or temporary cell (TC)-RNTI and transmitted in Type1-PDCCH CSS set.

A DL-related DCI Format (e.g., DCI Format 1_1 or DCI Format 1_2), with or without DL assignment, can indicate to a UE through a field “transmission configuration indication” a TCI state code point, wherein, the TCI state codepoint can be one of (1) a DL TCI state; (2) an UL TCI state; (3) a joint TCI state; or (4) a pair of DL TCI state and UL TCI state. TCI state code points are activated by MAC CE signaling.

Quasi-co-location (QCL) relation, can be quasi-location with respect to one or more of the following relations [38.214[REF4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel and sounding reference signal (SRS).

A “reference RS” corresponds to a set of characteristics of a DL beam or an UL TX beam, such as a direction, a precoding/beamforming, a number of ports, and so on.

On a Uu interface, a TCI state can be used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

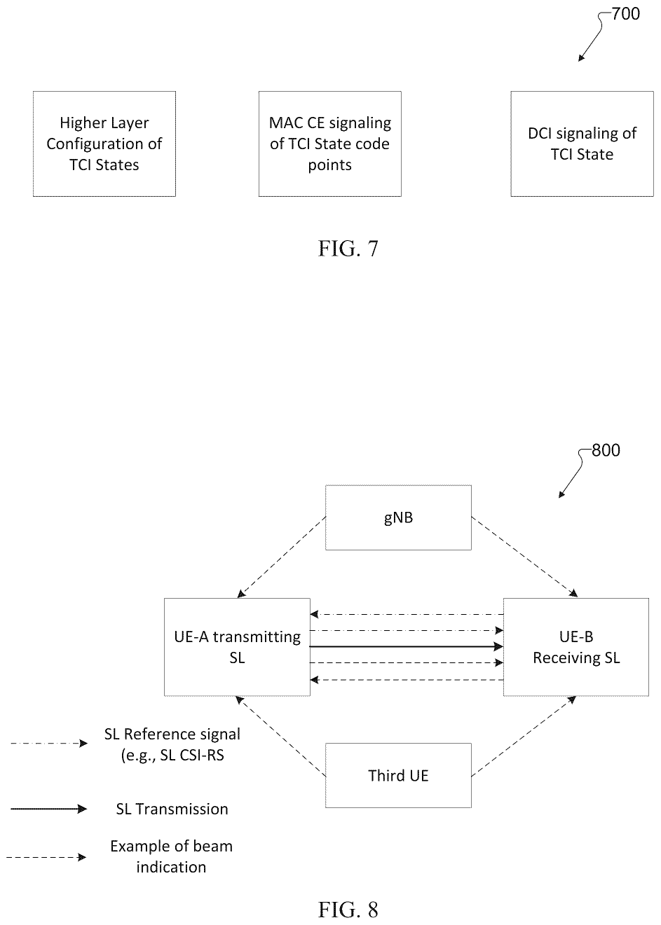

FIG. 7 illustrates a diagram of an example MAC CE signaling 700 according to embodiments of the present disclosure. For example, MAC CE signaling 700 can be received by any of the UEs 111-116 of FIG. 1. This example is for illustration only and other embodiments can be used without departing from the scope of the present disclosure.

A UE can be configured/updated through higher layer RRC signaling (as illustrated in FIG. 7) a set of TCI States with N elements. In one example, DL and joint TCI states are configured by higher layer parameter DLorJoint-TCIState, wherein, the number of DL and Joint TCI state is N_{DJ}. UL TCI state are configured by higher layer parameter UL-TCIState, wherein the number of UL TCI state is N_{U}. N=N_{DJ}+N_{U}. The DLorJoint-TCIState can include DL or Joint TCI states that belong to a serving cell, e.g., the source RS of the TCI state is associated with the serving cell (the PCI of the serving cell). Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell). Additionally, the UL TCI states can be associated with a cell having a PCI different from the PCI of the serving cell, e.g., the source RS of the TCI state is associated with a cell having a PCI different from the PCI of the serving cell.

With reference to FIG. 7, MAC CE signaling includes activating a subset of M (M≤N) TCI states or TCI state code points from the set of N TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e., Downlink Control Information (DCI)) updates the UE's TCI state, wherein the DCI includes a “transmission configuration indication” (beam indication) field e.g., with m bits (such that M≤2^{m}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

Various embodiments of the present disclosure provide for slot structure and signaling for SL CSI-RS. Various embodiments of the present disclosure recognize and take into consideration that 3GPP Release 16 is the first NR release to include sidelink through work item “5G V2X with NR sidelink”, the mechanisms introduced focused mainly on vehicle-to-everything (V2X), and can be used for public safety when the service requirement can be met. Release 17 extends sidelink support to more use cases through work item “NR Sidelink enhancement” (RP-201385). Release 18 considers further evolution of the NR SL air interface for operation in unlicensed bands, beam-based operation in FR2, SL carrier aggregation and co-channel co-existence between LTE SL and NR SL. One of the key features of NR is its ability to support beam-based operation. This is especially important for operation in FR2 which suffers a higher propagation loss. In Rel-16 and Rel-17 the main focus of developing SL was FR1. Indeed, the frequency bands supported for SL in Rel-16 and Rel-17 are all sub-6 GHz frequencies (bands n14, n38, n47, and n79). One of the objectives of Rel-18 is to expand SL to FR2, while SL supports SL phase tracking reference signal (PTRS), an important feature to support operation in FR2, i.e., beam management, is missing. Various embodiments of the present disclosure provide aspects related to SL CSI-RS design: (1) Slot structure for SL CSI-RS including mapping between control information and SL CSI-RS. (2) Content of control information associated with SL CSI-RS.

Various embodiments of the present disclosure relate to a 5G/NR communication system. Various embodiments of the present disclosure provide aspects related to SL CSI-RS design for beam management in SL FR2.

In this disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In this disclosure MAC CE signaling includes: (1) MAC CE signaling over the Uu interface, and/or (2) MAC CE signaling over the PC5 or SL interface.

In this disclosure L1 control signaling includes: (1) L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In this disclosure a gap symbol between transmissions within a slot or at the end of the slot can also be referred to as a guard symbol. This is a symbol with no SL transmission.

In this disclosure a slot can refer to (1) a logical slot in a SL resource pool, e.g., a slot ID or index can be a logical slot ID or index and/or a physical slot, e.g., a slot ID or index can be a physical slot ID or index. In this disclosure, a time duration can be in units of (1) logical slots in a resource pool, and/or (2) logical slots that can be in a resource pool, and/or (3) physical slots or subframes, or frames, and/or (4) time in units of a time unit such as μs, or ms or second.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. We refer to a first UE as UE-A and to a second UE as UE-B. In one example, UE-A is transmitting SL data on PSSCH/PSCCH, and UE-B is receiving the SL data on PSSCH/PSCCH. However, the roles of UE-A and UE-B can be switched.

In this disclosure a beam is also referred to as a spatial domain filter. For example, a transmit beam is a spatial domain transmission (or transmit) filter, and a receive beam is a spatial domain reception (or receive) filter.

FIG. 8 illustrates an example of SL signaling 800 in a wireless communication system according to embodiments of the present disclosure. For example, the SL signaling 800 can be implemented by one or more of the UEs 111-111C and BS 102 of FIG. 1. This example is for illustration only and other embodiments can be used without departing from the scope of the present disclosure.

For mmWave bands (or FR2) or for higher frequency bands (such as >52.6 GHz) where multi-beam operation is especially relevant, a transmission-reception process includes beam-based operation and beam management. Wherein, a first SL UE, e.g., UE-A, is communicating with a second SL UE, e.g., UE-B. UE-A uses a transmit beam (e.g., spatial domain transmission filter) to transmit a SL transmission to UE-B, and UE-B uses a receive beam (e.g., spatial domain reception filter) to receive a SL transmission from UE-A. UE-B uses a transmit beam (e.g., spatial domain transmission filter) to transmit a SL transmission to UE-A, and UE-A uses a receive beam (e.g., spatial domain reception filter) to receive the SL transmission from UE-B. During the initiation of a communication session between UE-A and UE-B a beam pair is determined for communication from UE-A to UE-B, i.e., a transmit beam from UE-A is paired with a receive beam from UE-B. A beam pair is also determined for communication from UE-B to UE-A, i.e., a transmit beam from UE-B is paired with a receive beam from UE-A. During a communication session between UE-A and UE-B, the beam pairs are updated and/or refined as the UEs move around or the radio environment changes, and new beams are used for communication between UE-A and UE-B.
This can require UE-A and/or UE-B to perform measurements to identify new beam or beams. The measurements can be performed on reference signal such as SL CSI-RS, wherein, as illustrated in FIG. 8, UE-A can transmit the reference signal (e.g., SL CSI-RS) using one or more transmit beams or spatial domain transmission filters, and UE-B can measure a metric associated with the reference signal (e.g., SL reference signal received power (RSRP), SL signal-to-interference-and-noise-ratio (SINR), channel quality indicator (CQI), block error rate (BLRE), etc.). UE-B can measure the reference signal (e.g., SL CSI-RS) using different receive beams (or spatial domain reception filters). The roles of UE-A and UE-B can be reversed. If UE-A is measuring the SL reference signal, it can use the measurement to determine a beam for communication with UE-B or send a measurement report to another entity (e.g., UE-B, or a third UE or a gNB) to determine the beam. If UE-B is measuring the SL reference signal, it can use the measurement to determine a beam for communication with UE-A or send a measurement report to another entity (e.g., UE-A, or a third UE or a gNB) to determine the beam.
This can also require UE-A to indicate to UE-B or vice versa, a new beam, or it would require a gNB (network) to indicate a new beam, or it would require a third SL UE (e.g., other than UE-A and UE-B) to indicate a new beam. The new beam can be indicated from the UE transmitting the SL transmission or from the UE receiving the SL transmission or from the gNB or from a third UE as illustrated in FIG. 8. The indication can be based on the aforementioned measurement.

In this disclosure, a gNB can be replaced by eNB or TRP or other network device or element sending messages to a UE. A third UE can be a platoon leader, a group leader, a radio side unit (RSU), or any other UE.

In this disclosure a beam report or beam measurement report can be (1) a periodic report, e.g., preconfigured or configured by higher layers, (2) a semi-persistent report that is activated and/or deactivated by dynamic signaling, e.g., MAC CE signaling and/or L1 control signaling, or (3) aperiodic report that is triggered by dynamic signaling, e.g., L1 control signaling and/or MAC CE signaling.

In this disclosure, the container of a report or message (e.g., beam report (or beam measurement report) or a beam indication message or trigger/activation/deactivation of a reference signal) can be:
Higher layer e.g., MAC CE or RRC report, for example MAC CE report can reuse the MAC CE CSI report on the SL PC5 interface,
SCI report container, the SCI report container can be first stage SCI (e.g., conveyed by PSCCH) and/or a second stage SCI (e.g., conveyed by PSSCH). In one example, the second stage SCI is a standalone second stage SCI in PSSCH, with no sidelink shared channel (SL-SCH) in PSSCH. In another example, the second stage SCI is multiplexed in PSSCH with a higher layer message, e.g., MAC CE carrying the beam report (or beam measurement report) with no other SL data. In another example, the second stage SCI is multiplexed in PSSCH with a higher layer message, e.g., MAC CE carrying the beam report (or beam measurement report) and other SL data. In another example, the second stage SCI is multiplexed in PSSCH with other SL data e.g., in a SL-SCH.
PSFCH report container. In one example, the PSFCH can be redesigned to carry more than one bit of information, e.g., a PSFCH with N bits of information and N>1. In one example, a beam report (or beam measurement report) is one bit, for example, indicating if a beam is good (e.g., valid) or bad (e.g., invalid). In one example, a beam report (or beam measurement report) is N bits, with N being a small number and N PSFCHs are used.
If a UE is in network coverage, the report or message can be sent to the network using UCI on PUCCH or PUSCH and/or the report or message can be sent to the network using higher layer message, e.g., MAC CE on the Uu interface.

In this disclosure, a beam can be identified for communication between a first UE and a second UE. In one example for the first UE, a same beam is used to transmit PSSCH/PSCCH and PSFCH from the first UE to the second UE. In one example, for the first UE, a same beam is used to receive PSSCH/PSCCH and PSFCH at the first UE from the second UE. In one example for the first UE, different beams are used to transmit PSSCH/PSCCH and PSFCH from the first UE to the second UE. In one example, for the first UE, different beams are used to receive PSSCH/PSCCH and PSFCH at the first UE from the second UE. In one example for the first UE, different beams are used to transmit PSSCH and PSCCH from the first UE to the second UE. In one example, for the first UE, different beams are used to receive PSSCH and PSCCH at the first UE from the second UE. The roles of the first and second UEs can be interchanged.

In one example, a UE can have beam correspondence, without beam sweeping, between the transmit beam and receive beam, for example, if the transmit beam to a second UE is known, the receive beam from the second UE is also known without beam sweeping. In one example, a UE can have beam correspondence, without beam sweeping, between the transmit beam and receive beam, for example, if the receive beam from a second UE is known, the transmit beam to the second UE is also known without beam sweeping. In one example, a UE performs beam sweeping to determine a receive beam from a second UE, regardless of whether or not it knows a transmit beam to the second UE. In one example, a UE performs beam sweeping to determine a transmit beam to a second UE, regardless of whether or not it knows a receive beam from the second UE.

The reference signal used for beam measurement can be a SL CSI-RS, where the SL CSI-RS sequence r(m) is provided by, e.g., as described in TS 38.211, by:

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

Where, m=0,1, . . .

The pseudo-random sequence c(n) can be a length-31 Gold sequence defined as

$$c ( n ) = ( {x}_{1} ( n + {N}_{c} ) + {x}_{2} ( n + {N}_{c} ) ) mod 2$$

### Where,

$$\begin{matrix}{N}_{c} = 1600 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2\end{matrix}$$

The first m-sequence is initialized with x₁(0)=1, and x₂(n)=0, for n=1 . . . 30.

The second m-sequence is initialized with cᵢₙᵢₜ, where cᵢₙᵢₜ

$${c}_{init} - ( {2}^{10} ( {N}_{symb}^{slot} {n}_{s , f}^{μ} + l + 1 ) ( 2 {n}_{ID} + 1 ) + {n}_{ID} ) mod {2}^{31}$$

Where,
N_{symb}^{slot} is the number of symbols in a slot (e.g., N_{symb}^{slot}=14)
n_{s,f}^{μ} is the slot number within a frame for sub-carrier spacing configuration μ.
l is the OFDM symbol number in a slot.
n_{ID}=N_{ID}^{x} mod 2¹⁰, where N_{ID}^{x} is the decimal representation of CRC of the first stage SL control information carried on PSCCH.

In a variant example, n_{ID} is provided is a pre-configured value, or is a value configured by higher layer (e.g., RRC) configuration.

In a variant example, n_{ID} depends on the spatial domain transmission filter used to transmit SL CSI-RS. In one example, there can be N n_{ID} that can be pre-configured or configured by higher layer (e.g., RRC), a UE may assume that for a same n_{ID} a same spatial domain transmission filter is used. In one example, N can be pre-configured, and/or configured or updated by RRC signaling from a network and/or RRC signaling over PC5 and/or MAC CE signaling and/or L1 control signaling. In one example, N can be specified in the system specifications. In one example, if N is not (pre-)configured, a default value specified in the system specification is used. In one example, there can be N spatial domain transmission filters. In one example, there can be N or less spatial domain transmission filters.

The mapping of the aforementioned sequence to resource elements can be given by (e.g., as described in TS 38.211), for resource element (k, l)_{p, μ}, where k is the subcarrier index, with k=0 is sub-carrier 0 in resource block 0. l is is the OFDM symbol number in a slot. p is the antenna port. μ is the sub-carrier spacing configuration.

$${a}_{k , l}^{( p , μ )} = {β}_{CSIRS} {w}_{f} ( {k}^{′} ) \cdot {w}_{t} ( {l}^{′} ) \cdot {r}_{l , {n}_{s , f}} ( {m}^{′} )$$

Where,

$$\begin{matrix}{m}^{′} = ⌊ n α ⌋ + {k}^{′} + ⌊ \frac{\overline{k} ρ}{{N}_{sc}^{RB}} ⌋ \\ k = {nN}_{sc}^{RB} + \overline{k} + {k}^{′} \\ l = \overline{l} + {l}^{′} \\ α = \{ \begin{matrix}ρ & X = 1 \\ 2 ρ & X > 1\end{matrix} \\ n = 0 , 1 , …\end{matrix}$$

β_{CSIRS} is a scaling factor for power.
ρ is the density as described later in this disclosure.
X is the number of antenna ports.
w_{f}(k′) is a function that depends on the code division multiplexing (CDM) pattern in the frequency domain, In one example, if there is no frequency domain CDM multiplexing, k′=0 and w_{f} (0)=1.
wₜ(l′) is a function that depends on the CDM pattern in the time domain, In one example, if there is no time domain CDM multiplexing, l′=0 and wₜ(0)=1.
k̅ is the starting position of a sub-carrier of SL CSI-RS in a PRB and can be pre-configured or configured as described later in this disclosure.
l̅ is the starting position of a symbol SL CSI-RS in a slot and can be pre-configured or configured as described later in this disclosure.

In one example, the number of antenna ports can be 1 antenna port or 2 antenna ports. In one example, if the number of antenna ports is 1, the code-division multiplexing (CDM) Type is no CDM (e.g., CDM Type is noCDM). If the number of antenna ports is 2, the CDM type can be frequency domain CDM over two resource elements (e.g., CDM type is fd-CDM2, and a CDM group has two elements), where the frequency domain sequence of each antenna port is given by:

| Index (e.g., antenna port) | [w_{f}(0) w_{f}(1)] |
|---|---|
| 0 | [+1 +1] |
| 1 | [+1 −1] |

In one example, the density, p, of SL CSI-RS can be ρ=1, e.g., a UE transmitting SL CSI-RS transmits one sub-carrier or one sub-carrier CDM group per PRB.

In one example, the density, p, of SL CSI-RS can be ρ=3, e.g., a UE transmitting SL CSI-RS transmits three sub-carriers or three sub-carrier CDM groups per PRB.

In another example, the density p, of SL CSI-RS can be ρ=0.5, e.g., a UE transmitting SL CSI-RS transmits one sub-carrier or one sub-carrier CDM group per two PRBs, the sub-carrier transmitted can be in an even PRB or in an old PRB.

In one example, a higher layer parameter for SL CSI-RS can indicate the density of the SL CSI-RS, for example, the allowed values indicated by density can be (1) one, (2) 0.5, using even PRBs, or (3) 0.5, using odd PRBs.

In one example, a high layer parameter, e.g., sl-CSI-RS-FirstSymbol, indicates the first OFDM symbol in a PRB used for SL CSI-RS.

In one example, a higher layer parameter, e.g., sl-CSI-RS-FreqAllocation, indicates the number of antenna ports and the frequency domain allocation for SL CSI-RS, wherein the frequency domain allocation is a bit map. For example, sl-CSI-RS-FreqAllocation, is given by:

```
sl-CSI-RS-FreqAllocation CHOICE{
  sl-OneAntennaPort Bit string of size 12
  sl-TwoAntennaPort Bit string of size 6
}
```

In one example, k̅ depends on the bit string and the number of antenna ports. In one example, if the number of antenna ports is 1, and bit n of the bit string is set to “1”, where n=0, 1, . . . , 11, k̅=n. In one example, if the number of antenna ports is 2, and bit n of the bit string is set to “1”, where n=0, 1, . . . , 5, k̅=2n. In example, if the frequency domain CDM group size is F, the number of bits in the bit string can be M, where

$$M = \frac{{N}_{sc}^{RB}}{F} or M = ⌈ \frac{{N}_{sc}^{RB}}{F} ⌉ or M = ⌊ \frac{{N}_{sc}^{RB}}{F} ⌋ ,$$

and N_{sc}^{RB}=12. If bit n of a bit string is set to “1”, where n=0, 1, . . . , M−1, k̅=n*F. In example, F=1 and M=12. In example, F=2 and M=6. In example, F=3 and M=4. In example, F=4 and M=3. In example, F=6 and M=2. In one example, one bit in the bit string is set to 1 (e.g., a single value for k̅). In one example, one or more bits in the bit string can be set to 1 (e.g., one or more values for k̅).

In one example, a higher layer parameter, for example first_SLCSIRS_OFDM_Symbol, can provide l̅.

In one example, a higher layer can provide L first_SLCSIRS_OFDM_Symbol, for l̅.

In one example, l̅ can be provided by a bitmap, e.g., a bitmap within a slot. In one example, the bitmap is for the symbols. In in example, the bitmap is for time domain CDM group. In one example, one bit in the bitmap can be set to 1 (e.g., a single value for l̅). In one example, one or more bits in the bitmap can be set to 1 (e.g., one or more values for l̅).

In one example, the SL CSI-RS symbols are repeated N times, wherein l can be given by l=l̅+l′+n. In one example, n=0, 1, . . . N−1. In example, n=0, 1, . . . M−1, where

$$M = \frac{N}{G} or M = ⌈ \frac{N}{G} ⌉ or M = ⌊ \frac{N}{G} ⌋ ,$$

and G is the size of the time domain CDM group. In one example, G=1. In one example, G=2. In one example, G=3. In one example, G=4. In one example, N can be pre-configured, and/or configured or updated by RRC signaling from a network and/or RRC signaling over PC5 and/or MAC CE signaling and/or L1 control signaling. In one example, N can be specified in the system specifications. In one example, if N is not (pre-)configured, a default value specified in the system specification is used.

In one example, the SL CSI-RS time domain CDM group are repeated N times, wherein l can be given by l=l̅+l′+G*n. In one example, n=0, 1, . . . N−1. Where, G is the size of the time domain CDM group. In one example, G=1. In one example, G=2. In one example, G=3. In one example, G=4. In one example, N can be pre-configured, and/or configured or updated by RRC signaling from a network and/or RRC signaling over PC5 and/or MAC CE signaling and/or L1 control signaling. In one example, N can be specified in the system specifications. In one example, if N is not (pre-)configured, a default value specified in the system specification is used.

In one example, when a SL CSI-RS is repeated across SL CSI-RS symbols or across SL CSI-RS time domain CDM groups a same antenna port or antenna ports are used across the repeated instances.

In one example, if the size for the frequency domain CDM group is F, and the size of the time domain CDM group is G. The size of the CDM group is F*G.

In one example, if the indexing of antenna ports across CDM groups can be first in order of frequency domain CDM groups, then in order of time domain CDM groups: (FD CDM group(0), TD CDM group(0)), (FD CDM group(1), TD CDM group(0)), . . . (FD CDM group(F-1), TD CDM group(0)), (FD CDM group(0), TD CDM group(1)), . . . , (FD CDM group(F-1), TD CDM group(1)), . . . , (FD CDM group(F-1), TD CDM group(G-1)).

In one example, if the indexing of antenna ports across CDM groups can be first in order of time domain CDM groups, then in order of frequency domain CDM groups: (FD CDM group(0), TD CDM group(0)), (FD CDM group(0), TD CDM group(1)), . . . , (FD CDM group(0), TD CDM group(G-1)), (FD CDM group(1), TD CDM group(0)), . . . , (FD CDM group(1), TD CDM group(G-1)), . . . , (FD CDM group(F-1), TD CDM group(G-1)).

In one example, the SL CSI-RS transmission or reception is a non-standalone transmission or reception, wherein within a slot SL CSI-RS can be transmitted or received with PSCCH and PSSCH, e.g., with other SL data or SL information, e.g., as in Rel-16 of the 3GPP specifications. In one example, SL CSI-RS can be transmitted in a resource pool shared (e.g., common) with SL CSI-RS communications (or SL data transmission). In one example, SL CSI-RS transmission is done is backward compatible manner with earlier releases in a shared or common resource pool.

In one example, the SL CSI-RS transmission is a standalone transmission, with no SL data. In one example, SL CSI-RS can be transmitted in a resource pool shared with SL CSI-RS communications (or SL data transmission). In one example, SL CSI-RS transmission is done is backward compatible manner with earlier releases in a shared or common resource pool. In one example, SL CSI-RS can be transmitted in a resource dedicated for SL CSI-RS. In one example, SL CSI-RS can be transmitted in a resource dedicated for SL CSI-RS or SL PRS transmissions.

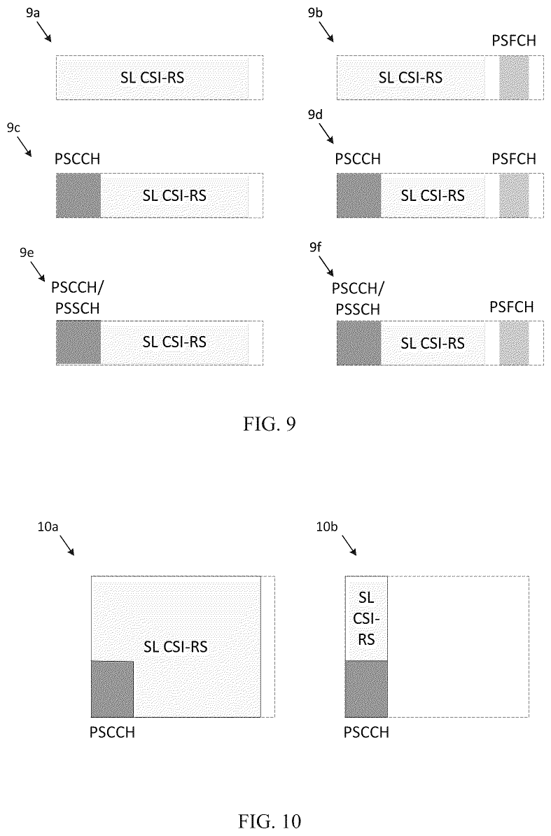

FIGS. 9 and 10 illustrates examples of structures for SL CSI-RS transmissions according to embodiments of the present disclosure. For example, the structures for SL CSI-RS transmissions can be utilized by the UE 116 of FIG. 2B. This example is for illustration only and other embodiments can be used without departing from the scope of the present disclosure.

In FIG. 9, SL CSI-RS shown is a SL CSI-RS region where SL CSI-RS can be transmitted. The SL CSI-RS region can include multiple OFDM symbols a UE can transmit SL CSI-RS on all, one or some of the multiple OFDM symbols. In one further example, the SL CSI-RS region can include one OFDM symbol.

In one example, a UE transmits or receives SL CSI-RS with no other SL channels or SL signals in a slot. This is illustrated by CSI-RS transmission structure 9a. In one example, there is a gap symbol after the SL CSI-RS transmission, as illustrated by CSI-RS transmission structure 9a. In one example, there is no gap symbol after the SL CSI-RS transmission.

In one example, a UE can transmit or receive SL CSI-RS with PSFCH in a slot. This illustrated by CSI-RS transmission structure 9b. In one example, there is a gap symbol between the last symbol of SL CSI-RS and PSFCH, as illustrated by CSI-RS transmission structure 9b. In another example, there is no gap symbol between the last symbol of SL CSI-RS and PSFCH.

In one example, a UE can transmit or receive SL CSI-RS with PSCCH in a slot. This illustrated by CSI-RS transmission structure 9c. In one example, the SL CSI-RS and PSCCH are in different symbols and there is no gap between PSCCH and SL CSI-RS, as illustrated by CSI-RS transmission structure 9c. In one example, the SL CSI-RS and PSCCH are in different symbols and there is a gap between PSCCH and SL CSI-RS. In one example, the SL CSI-RS and PSCCH can be transmitted or received in a same symbol, for example in different sub-channels or in different PRBs, or in different sub-carriers, and SL CSI-RS may also be transmitted or received individually in other symbols as illustrated by CSI-RS transmission structure 10a. In one example, the SL CSI-RS and PSCCH can be transmitted or received in a same symbol, for example in different sub-channels or in different PRBs, or in different sub-carriers, and SL CSI-RS is not transmitted nor received individually in other symbols as illustrated by CSI-RS transmission structure 10b. In one example, there is a gap symbol after the SL CSI-RS transmission, as illustrated by CSI-RS transmission structure 9c. In one example, there is no gap symbol after the SL CSI-RS transmission.

In one example, a UE can transmit or receive SL CSI-RS with PSCCH and/or PSFCH in a slot. This illustrated by CSI-RS transmission structure 9d. In one example, there is a gap symbol between the last symbol of SL CSI-RS and PSFCH, as illustrated by CSI-RS transmission structure 9d. In another example, there is no gap symbol between the last symbol of SL CSI-RS and PSFCH. In one example, the SL CSI-RS and PSCCH are in different symbols and there is no gap between PSCCH and SL CSI-RS, as illustrated by CSI-RS transmission structure 9d. In one example, the SL CSI-RS and PSCCH are in different symbols and there is a gap between PSCCH and SL CSI-RS. In one example, the SL CSI-RS and PSCCH can be transmitted or received in a same symbol, for example in different sub-channels or in different PRBs, or in different sub-carriers, and SL CSI-RS may also be transmitted or received individually in other symbols. In one example, the SL CSI-RS and PSCCH can be transmitted or received in a same symbol, for example in different sub-channels or in different PRBs, or in different sub-carriers, and SL CSI-RS is not transmitted nor received individually in other symbols.

In one example, a UE can transmit or receive SL CSI-RS with PSCCH and PSSCH in a slot, wherein, the PSSCH includes a second stage SCI. This illustrated by CSI-RS transmission structure 9e. In one example, the SL CSI-RS and PSCCH/PSSCH are in different symbols and there is no gap between PSCCH/PSSCH and SL CSI-RS, as illustrated by CSI-RS transmission structure 9e. In one example, the SL CSI-RS and PSCCH/PSSCH are in different symbols and there is a gap between PSCCH/PSSCH and SL CSI-RS. In one example, the SL CSI-RS and PSCCH and/or PSSCH can be transmitted or received in a same symbol, for example in different sub-channels or in different PRBs, or in different sub-carriers, and SL CSI-RS may also be transmitted or received individually in other symbols. In one example, the SL CSI-RS and PSCCH and/or PSSCH can be transmitted or received in a same symbol, for example in different sub-channels or in different PRBs, or in different sub-carriers, and SL CSI-RS is not transmitted nor received individually in other symbols. In one example, there is a gap symbol after the SL CSI-RS transmission, as illustrated by CSI-RS transmission structure 9e. In one example, there is no gap symbol after the SL CSI-RS transmission.

In one example, a UE can transmit or receive SL CSI-RS with PSCCH and PSSCH including a second stage SCI and/or PSFCH in a slot. This illustrated by CSI-RS transmission structure 9f. In one example, there is a gap symbol between the last symbol of SL CSI-RS and PSFCH, as illustrated by CSI-RS transmission structure 9f. In another example, there is no gap symbol between the last symbol of SL CSI-RS and PSFCH. In one example, the SL CSI-RS and PSCCH/PSSCH are in different symbols and there is no gap between PSCCH/PSSCH and SL CSI-RS, as illustrated by CSI-RS transmission structure 9f. In one example, the SL CSI-RS and PSCCH/PSSCH are in different symbols and there is a gap between PSCCH/PSSCH and SL CSI-RS. In one example, the SL CSI-RS and PSCCH and/or PSSCH can be transmitted or received in a same symbol, for example in different sub-channels or in different PRBs, or in different sub-carriers, and SL CSI-RS may also be transmitted or received individually in other symbols. In one example, the SL CSI-RS and PSCCH and/or PSSCH can be transmitted or received in a same symbol, for example in different sub-channels or in different PRBs, or in different sub-carriers, and SL CSI-RS is not transmitted nor received individually in other symbols.

In one example, as variant of aforementioned examples, a UE can transmit SL CSI-RS with PSCCH and PSSCH in a slot, wherein, the PSSCH includes a second stage SCI and a MAC CE (e.g., the MAC CE can include the information of the second stage SCI).

In one example, as variant of aforementioned examples, a UE can transmit SL CSI-RS with PSCCH and PSSCH in a slot, wherein, the PSSCH includes a second stage SCI and a MAC CE (e.g., the MAC CE can include the information of the second stage SCI), and wherein the slot can include PSFCH.

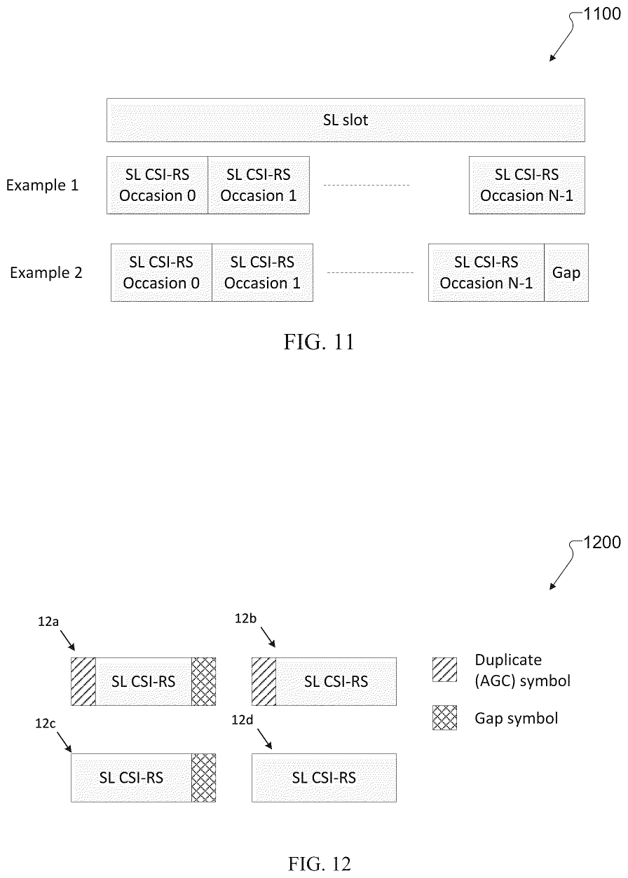

FIG. 11 illustrates examples of CSI-RS occasions 1100 in a SL slot according to embodiments of the present disclosure. For example, the CSI-RS occasions 1100 can be utilized by one or more of the UEs 111-111C of FIG. 1. This example is for illustration only and other embodiments can be used without departing from the scope of the present disclosure.

In one example, a slot can include multiple CSI-RS occasions. Each CSI-RS occasion can be associated with a transmit beam of a spatial domain transmission filter or a spatial relation. This is illustrated in FIG. 11.

FIG. 12 illustrates examples of structures for CSI-RS transmissions according to embodiments of the present disclosure. For example, the structures for CSI-RS transmissions 1200 can be utilized by one or more of the UEs 111-111C of FIG. 1. This example is for illustration only and other embodiments can be used without departing from the scope of the present disclosure.

In one example, a SL CSI-RS occasion includes CSI-RS. In one example, the first symbol of the SL CSI-RS occasion is a duplicate (or AGC) symbol (e.g., a duplicate of the second symbol or a duplicate of the last symbol of the CSI-RS transmission), and the last symbol of the SL CSI-RS occasion is a gap symbol. This is illustrated by CSI-RS transmission structure 12a. In one example, the first symbol of the SL CSI-RS occasion is a duplicate (or AGC) symbol (e.g., a duplicate of the second symbol or a duplicate of the last symbol of the CSI-RS transmission), and there is no gap after the SL CSI-RS transmission. This is illustrated by CSI-RS transmission structure 12b. In one example, there is no duplicate (or AGC) symbol for SL CSI-RS, and the last symbol of the SL CSI-RS occasion is a gap symbol. This is illustrated by CSI-RS transmission structure 12c. In one example, there is no duplicate (or AGC) symbol for SL CSI-RS, and there is no gap after the SL transmission. This is illustrated by CSI-RS transmission structure 12d.

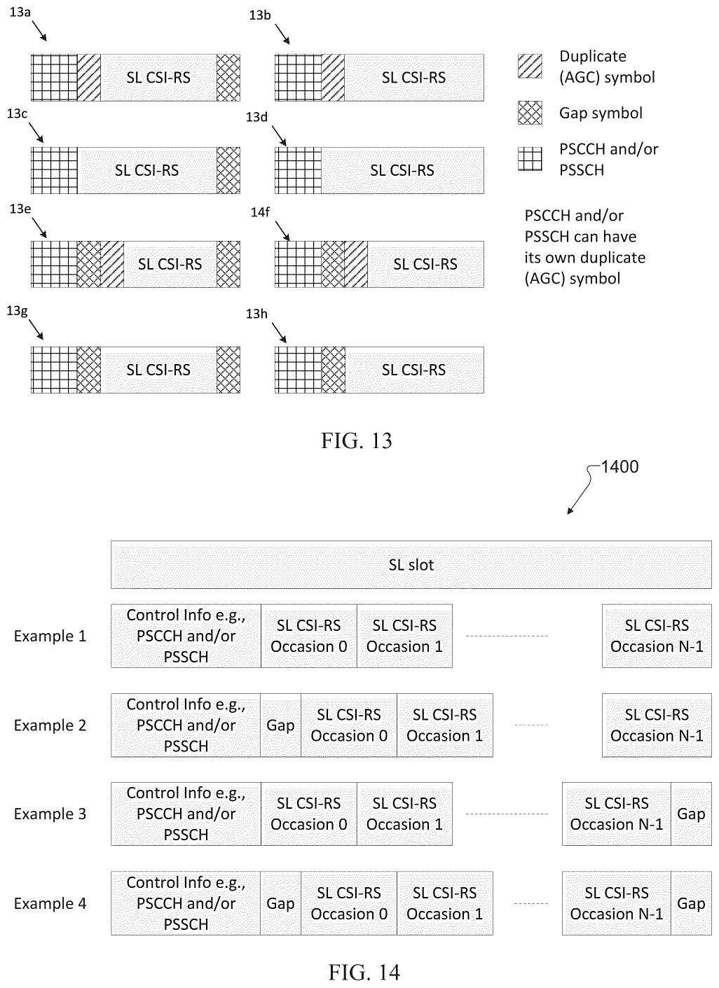

FIG. 13 illustrates examples of structures for CSI-RS transmissions according to embodiments of the present disclosure. For example, the structures for CSI-RS transmissions can be utilized by one or more of the UEs 111-111C of FIG. 1. This example is for illustration only and other embodiments can be used without departing from the scope of the present disclosure.

In one example, a SL CSI-RS occasion includes CSI-RS and associated control information. In one example, the associated control information can be in a PSCCH transmission (e.g., first stage SCI or single stage SCI). In one example, the associated control information can be in a PSSCH transmission (e.g., second stage SCI and/or MAC CE). In one example, the associated control information can be in a PSCCH transmission (e.g., first stage SCI) and in a PSSCH transmission (e.g., second stage SCI and/or MAC CE). In one example, the PSCCH and/or PSSCH are in different symbols from the symbols of the SL CSI-RS. In one example, SL CSI-RS can share some of the symbols of PSCCH and/or PSSCH, e.g., as illustrated by CSI-RS transmission structure 10a and 10b, where the transmission can be considered in a SL CSI-RS occasion.

FIG. 13 illustrates various examples, of structure of a SL CSI-RS occasion. “PSCCH and/or PSSCH” can include control information associated with SL CSI-RS. In one example, “PSCCH and/or PSSCH” can be PSCCH only. In one example, “PSCCH and/or PSSCH” can be PSSCH only. In one example, “PSCCH and/or PSSCH” can be PSCCH and PSSCH. “PSCCH and/or PSSCH” can have its own duplicate (or AGC) symbol at the start of its transmission. In one example, the frequency span of “PSCCH and/or PSSCH” is the same as the frequency span of SL CSI-RS. In one example, the frequency span of “PSCCH and/or PSSCH” can be different from the frequency span of SL CSI-RS. “PSCCH and/or PSSCH” can be considered as the control region or control part of the SL CSI-RS occasion. In one example, there can be multiple “PSCCH and/or PSSCH” occasions within the control region or control part with a mapping to SL CSI-RS resources in the SL CSI-RS occasion as described later in this disclosure.

In one example, as illustrated by CSI-RS transmission structure 13a, there is no gap between “PSCCH and/or PSSCH” and SL CSI-RS. The first symbol of the SL CSI-RS is a duplicate (or AGC) symbol (e.g., a duplicate of the second symbol or a duplicate of the last symbol of the CSI-RS transmission), and the last symbol of the SL CSI-RS occasion is a gap symbol.

In one example, as illustrated by CSI-RS transmission structure 13b, there is no gap between “PSCCH and/or PSSCH” and SL CSI-RS. The first symbol of the SL CSI-RS is a duplicate (or AGC) symbol (e.g., a duplicate of the second symbol or a duplicate of the last symbol of the CSI-RS transmission), and there is no gap after the SL transmission.

In one example, as illustrated by CSI-RS transmission structure 13c, there is no gap between “PSCCH and/or PSSCH” and SL CSI-RS. There is no duplicate (or AGC) symbol for SL CSI-RS, and the last symbol of the SL CSI-RS occasion is a gap symbol.

In one example, as illustrated by CSI-RS transmission structure 13d, there is no gap between “PSCCH and/or PSSCH” and SL CSI-RS. There is no duplicate (or AGC) symbol for SL CSI-RS, and there is no gap after the SL transmission.

In one example, as illustrated by CSI-RS transmission structure 13e, there is a gap symbol between “PSCCH and/or PSSCH” and SL CSI-RS. The first symbol of the SL CSI-RS is a duplicate (or AGC) symbol (e.g., a duplicate of the second symbol or a duplicate of the last symbol of the CSI-RS transmission), and the last symbol of the SL CSI-RS occasion is a gap symbol.

In one example, as illustrated by CSI-RS transmission structure 13f, there is a gap symbol between “PSCCH and/or PSSCH” and SL CSI-RS. The first symbol of the SL CSI-RS is a duplicate (or AGC) symbol (e.g., a duplicate of the second symbol or a duplicate of the last symbol of the CSI-RS transmission), and there is no gap after the SL transmission.

In one example, as illustrated by CSI-RS transmission structure 13g, there is a gap symbol between “PSCCH and/or PSSCH” and SL CSI-RS. There is no duplicate (or AGC) symbol for SL CSI-RS, and the last symbol of the SL CSI-RS occasion is a gap symbol.

In one example, as illustrated by CSI-RS transmission structure 13h, there is a gap symbol between “PSCCH and/or PSSCH” and SL CSI-RS. There is no duplicate (or AGC) symbol for SL CSI-RS, and there is no gap after the SL transmission.

In one example for FIG. 13, a same beam or spatial domain filter or spatial relation is used for the control part (e.g., “PSCCH and/or PSSCH” and for a corresponding SL CSI-RS.

In one example for FIG. 13, a different beam or spatial domain filter or spatial relation can be used for the control part (e.g., “PSCCH and/or PSSCH” and for a corresponding SL CSI-RS.

FIG. 14 illustrates examples of CSI-RS occasions 1400 in a SL slot according to embodiments of the present disclosure. For example, the CSI-RS occasions 1400 can be utilized by one or more of the UEs 111-111C of FIG. 1. This example is for illustration only and other embodiments can be used without departing from the scope of the present disclosure.

In one example, a slot can include multiple CSI-RS occasions, and a control part or control region, wherein the control part or region can be a PSCCH and/or PSSCH. This is illustrated in FIG. 14. “PSCCH and/or PSSCH” can include control information associated with SL CSI-RS. In one example, “PSCCH and/or PSSCH” (control region) can be PSCCH only. In one example, “PSCCH and/or PSSCH” (control region) can be PSSCH only. In one example, “PSCCH and/or PSSCH” (control region) can be PSCCH and PSSCH. “PSCCH and/or PSSCH” can have its own duplicate (or AGC) symbol at the start of its transmission. In one example, the frequency span of “PSCCH and/or PSSCH” is the same as the frequency span of SL CSI-RS. In one example, the frequency span of “PSCCH and/or PSSCH” can be different from the frequency span of SL CSI-RS. In one example, there can be multiple “PSCCH and/or PSSCH” occasions within the control region or control part with a mapping to SL CSI-RS resources of the slot as described later in this disclosure. In one example of FIG. 14, there is no gap symbol after the last SL CSI-RS occasion and between the control region and first SL CSI-RS occasion. In one example of FIG. 14, there is no gap symbol after the last SL CSI-RS occasion but there is a gap symbol between the control region and first SL CSI-RS occasion. In one example of FIG. 14, there is a gap symbol after the last SL CSI-RS occasion and but there is no gap symbol between the control region and first SL CSI-RS occasion. In one example of FIG. 14, there is a gap symbol after the last SL CSI-RS occasion and a second gap symbol between the control region and first SL CSI-RS occasion. In one example, a SL CSI-RS occasion with a SL CSI-RS transmission from a UE can be associated with a transmit beam of a spatial domain transmission filter or a spatial relation.

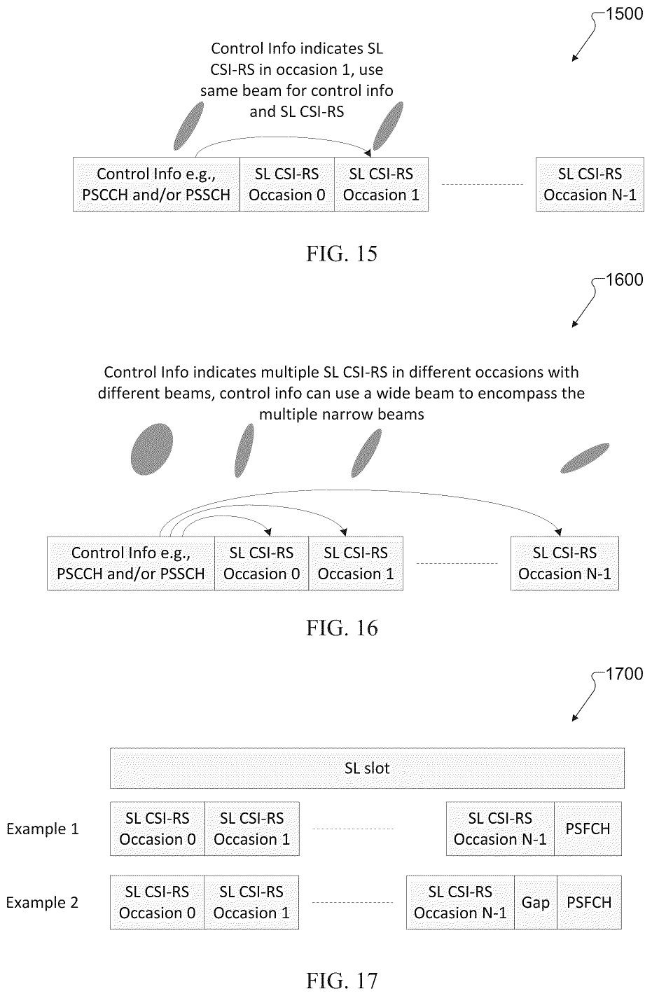

FIG. 15 illustrates an example for SL CSI-RS occasions 1500 where a same beam or spatial domain filter or spatial relation is used for the control part according to embodiments of the present disclosure. For example, the SL CSI-RS occasions 1500 can be utilized by one or more of the UEs 111-111C of FIG. 1. This example is for illustration only and other embodiments can be used without departing from the scope of the present disclosure.

In one example for FIG. 14, a same beam or spatial domain filter or spatial relation is used for the control part (e.g., “PSCCH and/or PSSCH” and for a corresponding SL CSI-RS, for example as illustrated in FIG. 15.

FIG. 16 illustrates an example for SL CSI-RS occasions 1600 where a same beam or spatial domain filter or spatial relation is used for the control part according to embodiments of the present disclosure. For example, the SL CSI-RS occasions 1600 can be utilized by one or more of the UEs 111-111C of FIG. 1. This example is for illustration only and other embodiments can be used without departing from the scope of the present disclosure.

In one example for FIG. 14, a different beam or spatial domain filter or spatial relation can be used for the control part (e.g., “PSCCH and/or PSSCH” and for a corresponding SL CSI-RS, as illustrated in FIG. 16. For example, the “PSCCH and/or PSSCH” can include information for multiple SL CSI-RS, each SL CSI-RS with its own beam (e.g., narrow beam), the beam of the “PSCCH and/or PSSCH can be wide enough to cover multiple SL CSI-RS beams. The SL CSI-RS occasions for FIG. 14, can be as aforementioned and described in FIG. 12 or FIG. 13.

FIG. 17 illustrates examples of SL CSI-RS occasions 1700 in a SL slot according to embodiments of the present disclosure. For example, the SL CSI-RS occasions 1700 can be utilized by one or more of the UEs 111-111C of FIG. 1. This example is for illustration only and other embodiments can be used without departing from the scope of the present disclosure.

In one example, a slot can include multiple SL CSI-RS occasions, and a PSFCH. The PSFCH region of FIG. 17 includes a gap symbol at its end (at the end of the slot). This is illustrated in FIG. 17. In one example of FIG. 17, there is no gap symbol between the last SL CSI-RS occasion and the PSFCH. In one example of FIG. 17, there is a gap symbol between the last SL CSI-RS occasion and the PSFCH.

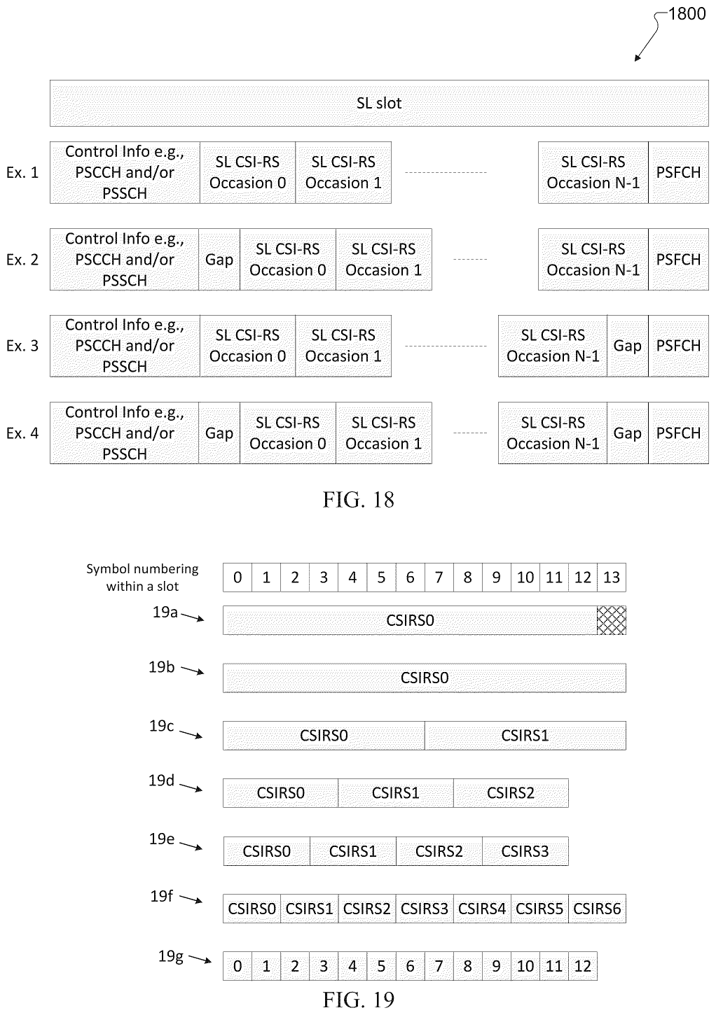

FIG. 18 illustrates examples of SL CSI-RS occasions 1800 in a SL slot according to embodiments of the present disclosure. For example, the SL CSI-RS occasions 1800 can be utilized by one or more of the UEs 111-111C of FIG. 1. This example is for illustration only and other embodiments can be used without departing from the scope of the present disclosure.

In one example, a slot can include (1) multiple CSI-RS occasions, (2) a control part region, wherein the control part or region can be a PSCCH and/or PSSCH, and (3) a PSFCH. The PSFCH region of FIG. 18 includes a gap symbol at its end (at the end of the slot). This is illustrated in FIG. 18. In one example of FIG. 18, there is no gap symbol between the last SL CSI-RS occasion and PSFCH, and there is no gap symbol between the control region and first SL CSI-RS occasion. In one example of FIG. 18, there is no gap symbol between the last SL CSI-RS occasion and PSFCH, but there is a gap symbol between the control region and first SL CSI-RS occasion. In one example of FIG. 18, there is a gap symbol between the last SL CSI-RS occasion and PSFCH, but there is no gap symbol between the control region and first SL CSI-RS occasion. In one example of FIG. 18, there is a gap symbol between the last SL CSI-RS occasion and PSFCH, and there is a gap symbol between the control region and first SL CSI-RS occasion.

In one example, the number of SL CSI-RS symbols in a SL CSI-RS occasion or in a slot can be pre-configured, and/or configured or updated by RRC signaling from a network and/or RRC signaling over PC5 and/or MAC CE signaling and/or L1 control signaling. In one example, the number of SL CSI-RS symbols in a SL CSI-RS occasion or in a slot can be specified in the system specifications, e.g., 1 symbol or 2 symbols. In one example, if the number of SL CSI-RS symbols in a SL CSI-RS occasion or in a slot is not (pre-)configured, a default value specified in the system specification is used.

In one example, the number of SL CSI-RS symbols in a SL CSI-RS occasion or in a slot includes the duplicate (AGC) symbol and the gap symbol.

In one example, the number of SL CSI-RS symbols in a SL CSI-RS occasion or in a slot includes the duplicate (AGC) symbol but not the gap symbol.

In one example, the number of SL CSI-RS symbols in a SL CSI-RS occasion or in a slot includes the gap symbol but not the duplicate (AGC) symbol.

In one example, the number of SL CSI-RS symbols in a SL CSI-RS occasion or in a slot includes neither the duplicate (AGC) symbol nor the gap symbol.

In one example, the number of symbols in a SL CSI-RS occasion includes the symbols in the control region and the symbols of SL CSI-RS in the SL CSI-RS occasion.

In one example, the number of symbols in a SL CSI-RS occasion includes the symbols in the control region and the symbols of SL CSI-RS in the SL CSI-RS occasion, including a duplicate AGC symbol at the start of the SL CSI-RS occasion.

In one example, the number of symbols in a SL CSI-RS occasion includes the symbols in the control region and the symbols of SL CSI-RS in the SL CSI-RS occasion, but doesn't include a duplicate AGC symbol at the start of the SL CSI-RS occasion.

In one example, the number of symbols in a SL CSI-RS occasion includes the symbols in the control region and the symbols of SL CSI-RS in the SL CSI-RS occasion, including a gap symbol at the end of the SL CSI-RS occasion.

In one example, the number of symbols in a SL CSI-RS occasion includes the symbols in the control region and the symbols of SL CSI-RS in the SL CSI-RS occasion, but doesn't include a gap symbol at the end of the SL CSI-RS occasion.

In one example, the number of SL CSI-RS occasions in a slot can be pre-configured, and/or configured or updated by RRC signaling from a network and/or RRC signaling over PC5 and/or MAC CE signaling and/or L1 control signaling. In one example the number of SL CSI-RS occasions in a slot can be specified in the system specifications, e.g., one occasion or two occasions. In one example, if the number of SL CSI-RS occasions in a slot is not (pre-)configured, a default value specified in the system specification is used.

FIG. 19 illustrates examples structures for of SL CSI-RS occasions in a SL slot according to embodiments of the present disclosure. For example, the structures for SL CSI-RS occasions can be utilized by one or more of the UEs 111-111C of FIG. 1. This example is for illustration only and other embodiments can be used without departing from the scope of the present disclosure.

In one example, the number of SL CSI-RS symbols in a SL CSI-RS occasion is determined based on the number of SL CSI-RS occasions. In one example, the number of SL CSI-RS symbols in a SL CSI-RS occasion can depend on whether the slot includes PSFCH or not. In one example, the number of SL CSI-RS symbols in a SL CSI-RS occasion can depend on whether the slot includes a control region (e.g., as illustrated in FIG. 14) or not (e.g., as illustrated in FIG. 11). In one example, the number of SL CSI-RS symbols in a SL CSI-RS occasion can depend on the length of the control region e.g., in symbols. Table 1 provides examples of slot structures.

In one example, the length of the control region in symbols in a SL CSI-RS occasion or in a slot can be pre-configured, and/or configured or updated by RRC signaling from a network and/or RRC signaling over PC5 and/or MAC CE signaling and/or L1 control signaling. In one example, the length of the control region in symbols in a SL CSI-RS occasion or in a slot can be specified in the system specifications. In one example, if the length of the control region in symbols in a SL CSI-RS occasion or in a slot is not (pre-)configured, a default value specified in the system specification is used. In one example, the length of the control region in symbols can exclude the duplicate (or AGC) symbol. In one example, the length of the control region in symbols can include the duplicate (or AGC) symbol. In one example, the length of the control region in symbols can be 1 or 2 or 3. In one example, the length of the control region in symbols can be 2 or 3.

TABLE 1

| Number of SL- | Control Region present? | | |
|---|---|---|---|
| CSI Occasions | If present length excluding | PSFCH | Number of SL CSI-RS symbols in |
| per slot | its duplicate (AGC) symbol | present? | a SL CSI-RS occasion |
| 1 | No-N/A | No | Up to 14 without gap symbol at |
| | | | end of slot-CSI-RS transmission |
| | | | structure 19b |
| | | | Up to 13 with gap symbol at end |
| | | | of slot-CSI-RS transmission |
| | | | structure 19a |
| 2 | No-N/A | No | Up to 7-CSI-RS transmission |
| | | | structure 19c |
| 3 | No-N/A | No | Up to 4-CSI-RS transmission |
| | | | structure 19d |
| 4 | No-N/A | No | Up to 3-CSI-RS transmission |
| | | | structure 19e |
| 5 or 6 or 7 | No-N/A | No | Up to 2-CSI-RS transmission |
| | | | structure 19f |
| 7 to 13 | No-N/A | No | 1-CSI-RS transmission structure |
| | | | 19g |
| 1 | No-N/A | Yes | Up to 11 without gap symbol |
| | | | between SL CSI-RS and PSFCH |
| | | | Up to 10 with gap symbol |
| | | | between SL CSI-RS and PSFCH |
| 2 | No-N/A | Yes | Up to 5 |
| 3 | No-N/A | Yes | Up to 3 |
| 4 or 5 | No-N/A | Yes | Up to 2 |
| 6 to 10 | No-N/A | Yes | 1 |
| 1 | Yes-2 symbols-no gap | No | Up to 11 without gap symbol at |
| | between PSCCH and/or | | end of slot |
| | PSSCH and SL CSI-RS | | Up to 10 with gap symbol at end |
| | | | of slot |
| 2 | Yes-2 symbols-no gap | No | Up to 5 |
| | between PSCCH and/or | | |
| | PSSCH and SL CSI-RS | | |
| 3 | Yes-2 symbols-no gap | No | Up to 3 |
| | between PSCCH and/or | | |
| | PSSCH and SL CSI-RS | | |
| 4 or 5 | Yes-2 symbols-no gap | No | Up to 2 |
| | between PSCCH and/or | | |
| | PSSCH and SL CSI-RS | | |
| 6 to 10 | Yes-2 symbols-no gap | No | 1 |
| | between PSCCH and/or | | |
| | PSSCH and SL CSI-RS | | |
| 1 | Yes-2 symbols-no gap | Yes | Up to 8 without gap symbol |
| | between PSCCH and/or | | between SL CSI-RS and PSFCH |
| | PSSCH and SL CSI-RS | | Up to 7 with gap symbol between |
| | | | SL CSI-RS and PSFCH |
| 2 | Yes-2 symbols-no gap | Yes | Up to 4 |
| | between PSCCH and/or | | |
| | PSSCH and SL CSI-RS | | |
| 3 or 4 | Yes-2 symbols-no gap | Yes | Up to 2 |
| | between PSCCH and/or | | |
| | PSSCH and SL CSI-RS | | |
| 5 to 7 | Yes-2 symbols-no gap | Yes | 1 |
| | between PSCCH and/or | | |
| | PSSCH and SL CSI-RS | | |
| 1 | Yes- | No | Up to 10 without gap symbol at |
| | 3 symbols & no gap or | | end of slot |
| | 2 symbols and gap between | | Up to 9 with gap symbol at end of |
| | PSCCH and/or PSSCH and | | slot |
| | SL CSI-RS | | |
| 2 | Yes- | No | Up to 5 |
| | 3 symbols & no gap or | | |
| | 2 symbols and gap between | | |
| | PSCCH and/or PSSCH and | | |
| | SL CSI-RS | | |
| 3 | Yes- | No | Up to 3 |
| | 3 symbols & no gap or | | |
| | 2 symbols and gap between | | |
| | PSCCH and/or PSSCH and | | |
| | SL CSI-RS | | |
| 4 or 5 | Yes- | No | Up to 2 |
| | 3 symbols & no gap or | | |
| | 2 symbols and gap between | | |
| | PSCCH and/or PSSCH and | | |
| | SL CSI-RS | | |
| 6 to 9 | Yes- | No | 1 |
| | 3 symbols & no gap or | | |
| | 2 symbols and gap between | | |
| | PSCCH and/or PSSCH and | | |
| | SL CSI-RS | | |
| 1 | Yes- | Yes | Up to 7 without gap symbol |
| | 3 symbols & no gap or | | between SL CSI-RS and PSFCH |
| | 2 symbols and gap between | | Up to 6 with gap symbol between |
| | PSCCH and/or PSSCH and | | SL CSI-RS and PSFCH |
| | SL CSI-RS | | |
| 2 | Yes- | Yes | Up to 3 |
| | 3 symbols & no gap or | | |
| | 2 symbols and gap between | | |
| | PSCCH and/or PSSCH and | | |
| | SL CSI-RS | | |
| 3 | Yes- | Yes | Up to 2 |
| | 3 symbols & no gap or | | |
| | 2 symbols and gap between | | |
| | PSCCH and/or PSSCH and | | |
| | SL CSI-RS | | |
| 4 to 6 | Yes- | Yes | 1 |
| | 3 symbols & no gap or | | |
| | 2 symbols and gap between | | |
| | PSCCH and/or PSSCH and | | |
| | SL CSI-RS | | |
| 1 | Yes- | No | Up to 9 without gap symbol at end |
| | 3 symbols & gap between | | of slot |
| | PSCCH and/or PSSCH and | | Up to 8 with gap symbol at end of |
| | SL CSI-RS | | slot |
| 2 | Yes- | No | Up to 4 |
| | 3 symbols & gap between | | |
| | PSCCH and/or PSSCH and | | |
| | SL CSI-RS | | |
| 3 | Yes- | No | Up to 3 |
| | 3 symbols & gap between | | |
| | PSCCH and/or PSSCH and | | |
| | SL CSI-RS | | |
| 4 | Yes- | No | Up to 2 |
| | 3 symbols & gap between | | |
| | PSCCH and/or PSSCH and | | |
| | SL CSI-RS | | |
| 5 to 8 | Yes- | No | 1 |
| | 3 symbols & gap between | | |
| | PSCCH and/or PSSCH and | | |
| | SL CSI-RS | | |
| 1 | Yes- | Yes | Up to 6 without gap symbol |
| | 3 symbols & gap between | | between SL CSI-RS and PSFCH |
| | PSCCH and/or PSSCH and | | Up to 5 with gap symbol between |
| | SL CSI-RS | | SL CSI-RS and PSFCH |
| 2 | Yes- | Yes | Up to 3 |
| | 3 symbols & gap between | | |
| | PSCCH and/or PSSCH and | | |
| | SL CSI-RS | | |
| 3 | Yes- | Yes | Up to 2 |
| | 3 symbols & gap between | | |
| | PSCCH and/or PSSCH and | | |
| | SL CSI-RS | | |
| 4 to 5 | Yes- | Yes | 1 |
| | 3 symbols & gap between | | |
| | PSCCH and/or PSSCH and | | |
| | SL CSI-RS | | |

In FIG. 19, if the gap symbol at the end of the slot is not present in the SL CSI-RS occasion, the duration of the SL CSI-RS occasion is shortened by 1 symbol to have a gap symbol at the end of the slot.

In Table 1, the SL slot is assumed to have 14 symbols. If the number of symbols in the SL slot is less than the 14, the duration of the SL CSI-RS or the number of SL CSI-RS occasions in a slot can be adjusted based on the number of available SL symbols.

In the following examples, the number of SL symbols in a SL slot is Nₛ. In one example, Nₛ=14. In one example, Nₛ is configured as aforementioned.

In one example, if there is no PSFCH and no control region in a slot, the (Number of SL CSI-RS symbols in a SL CSI-RS occasion)×(the number of SL CSI-RS occasions in a slot) is less than or equal to Nₛ, with the gap symbol at the end of the slot being included in the last SL CSI-RS occasion. In one example, the number of symbols per SL CSI-RS occasion can be different, the sum of symbols across all SL CSI-RS occasions is less than or equal to Nₛ. In one example,

$$( Number of SL CSI - RS symbols in a SL CSI - RS occasion ) = ⌊ \frac{{N}_{s}}{( the number of SL CSI - RS occasions in a slot )} ⌋$$

In one example,

$$( the number of SL CSI - RS occasions in a slot ) = ⌊ \frac{{N}_{s}}{( Number of SL CSI - RS symbols in a SL CSI - RS occasion )} ⌋$$

In one example, if there is no PSFCH and no control region in a slot, the (Number of SL CSI-RS symbols in a SL CSI-RS occasion)×(the number of SL CSI-RS occasions in a slot) is less than or equal to Nₛ−1, with a gap symbol at the end of the slot. In one example, the number of symbols per SL CSI-RS occasion can be different, the sum symbols across all SL CSI-RS occasions is less than or equal to Nₛ−1. In one example,

$$( Number of SL CSI - RS symbols in a SL CSI - RS occasion ) = ⌊ \frac{{N}_{s} - 1}{( the number of SL CSI - RS occasions in a slot )} ⌋$$

In one example,

$$( the number of SL CSI - RS occasions in a slot ) = ⌊ \frac{{N}_{s} - 1}{( Number of SL CSI - RS symbols in a SL CSI - RS occasion )} ⌋$$

In one example, if there is PSFCH but no control region in a slot, the (Number of SL CSI-RS symbols in a SL CSI-RS occasion)×(the number of SL CSI-RS occasions in a slot) is less than or equal to Nₛ−3, with the gap symbol between SL CSI-RS and PSFCH being included in the SL CSI-RS occasion. In one example, the number of symbols per SL CSI-RS occasion can be different, the sum symbols across all SL CSI-RS occasions is less than or equal to Nₛ−3. In one example,

$$( Number of SL CSI - RS symbols in a SL CSI - RS occasion ) = ⌊ \frac{{N}_{s} - 3}{( the number of SL CSI - RS occasions in a slot )} ⌋$$

In one example,

$$( the number of SL CSI - RS occasions in a slot ) = ⌊ \frac{{N}_{s} - 3}{( Number of SL CSI - RS symbols in a SL CSI - RS occasion )} ⌋$$

In one example, if there is PSFCH but no control region in a slot, the (Number of SL CSI-RS symbols in a SL CSI-RS occasion)×(the number of SL CSI-RS occasions in a slot) is less than or equal to Nₛ−4, with a gap symbol between SL CSI-RS and PSFCH. In one example, the number of symbols per SL CSI-RS occasion can be different, the sum symbols across all SL CSI-RS occasions is less than or equal to Nₛ−4. In one example,

$$( Number of SL CSI - RS symbols in a SL CSI - RS occasion ) = ⌊ \frac{{N}_{s} - 4}{( the number of SL CSI - RS occasions in a slot )} ⌋$$

In one example,

$$( the number of SL CSI - RS occasions in a slot ) = ⌊ \frac{{N}_{s} - 4}{( Number of SL CSI - RS symbols in a SL CSI - RS occasion )} ⌋$$

In one example, if there is no PSFCH but there is a control region in a slot with length 2 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to N₃−3, with the gap symbol at the end of the slot being included in the SL CSI-RS occasion. In one example, the number of symbols per SL CSI-RS occasion can be different, the sum symbols across all SL CSI-RS occasions is less than or equal to Nₛ−3. In one example,

$$( Number of SL CSI - RS symbols in a SL CSI - RS occasion ) = ⌊ \frac{{N}_{s} - 3}{( the number of SL CSI - RS occasions in a slot )} ⌋$$

In one example,

$$( the number of SL CSI - RS occasions in a slot ) = ⌊ \frac{{N}_{s} - 3}{( Number of SL CSI - RS symbols in a SL CSI - RS occasion )} ⌋$$

In one example, if there is no PSFCH but there is a control region in a slot with length 2 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−4, with a gap symbol at the end of the slot. In one example, the number of symbols per SL CSI-RS occasion can be different, the sum symbols across all SL CSI-RS occasions is less than or equal to Nₛ−4. In one example,

$$( Number of SL CSI - RS symbols in a SL CSI - RS occasion ) = ⌊ \frac{{N}_{s} - 4}{( the number of SL CSI - RS occasions in a slot )} ⌋$$

In one example,

$$( the number of SL CSI - RS occasions in a slot ) = ⌊ \frac{{N}_{s} - 4}{( Number of SL CSI - RS symbols in a SL CSI - RS occasion )} ⌋$$

In one example, if there is PSFCH and there is a control region in a slot with length 2 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−6, with the gap symbol between SL CSI-RS and PSFCH being included in the SL CSI-RS occasion. In one example, the number of symbols per SL CSI-RS occasion can be different, the sum symbols across all SL CSI-RS occasions is less than or equal to Nₛ−6. In one example,

$$( Number of SL CSI - RS symbols in a SL CSI - RS occasion ) = ⌊ \frac{{N}_{s} - 6}{( the number of SL CSI - RS occasions in a slot )} ⌋$$

In one example,

$$( the number of SL CSI - RS occasions in a slot ) = ⌊ \frac{{N}_{s} - 6}{( Number of SL CSI - RS symbols in a SL CSI - RS occasion )} ⌋$$

In one example, if there is PSFCH and there is a control region in a slot with length 2 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−7, with a gap symbol between SL CSI-RS and PSFCH. In one example, the number of symbols per SL CSI-RS occasion can be different, the sum symbols across all SL CSI-RS occasions is less than or equal to Nₛ−7. In one example,

$$( Number of SL CSI - RS symbols in a SL CSI - RS occasion ) = ⌊ \frac{{N}_{s} - 7}{( the number of SL CSI - RS occasions in a slot )} ⌋$$

In one example,

$$( the number of SL CSI - RS occasions in a slot ) = ⌊ \frac{{N}_{s} - 7}{( Number of SL CSI - RS symbols in a SL CSI - RS occasion )} ⌋$$

In one example, if there is no PSFCH but there is a control region in a slot with either (1) length 2 symbols excluding the duplicate (or AGC) symbol and a gap between the control region and the SL CSI-RS or (2) length 3 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−4, with the gap symbol at the end of the slot being included in the SL CSI-RS occasion. In one example, the number of symbols per SL CSI-RS occasion can be different, the sum symbols across all SL CSI-RS occasions is less than or equal to Nₛ−4. In one example,

$$( Number of SL CSI - RS symbols in a SL CSI - RS occasion ) = ⌊ \frac{{N}_{s} - 4}{( the number of SL CSI - RS occasions in a slot )} ⌋$$

In one example,

$$( the number of SL CSI - RS occasions in a slot ) = ⌊ \frac{{N}_{s} - 4}{( Number of SL CSI - RS symbols in a SL CSI - RS occasion )} ⌋$$

In one example, if there is no PSFCH but there is a control region in a slot with either (1) length 2 symbols excluding the duplicate (or AGC) symbol and a gap between the control region and the SL CSI-RS or (2) length 3 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−5, with a gap symbol at the end of the slot. In one example, the number of symbols per SL CSI-RS occasion can be different, the sum symbols across all SL CSI-RS occasions is less than or equal to Nₛ−5. In one example,

$$( Number of SL CSI - RS symbols in a SL CSI - RS occasion ) = ⌊ \frac{{N}_{s} - 5}{( the number of SL CSI - RS occasions in a slot )} ⌋$$

In one example,

$$( the number of SL CSI - RS occasions in a slot ) = ⌊ \frac{{N}_{s} - 5}{( Number of SL CSI - RS symbols in a SL CSI - RS occasion )} ⌋$$

In one example, if there is PSFCH and there is a control region in a slot with either (1) length 2 symbols excluding the duplicate (or AGC) symbol and a gap between the control region and the SL CSI-RS or (2) length 3 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−7, with the gap symbol between SL CSI-RS and PSFCH being included in the SL CSI-RS occasion. In one example, the number of symbols per SL CSI-RS occasion can be different, the sum symbols across all SL CSI-RS occasions is less than or equal to Nₛ−7. In one example,

$$( Number of SL CSI - RS symbols in a SL CSI - RS occasion ) = ⌊ \frac{{N}_{s} - 7}{( the number of SL CSI - RS occasions in a slot )} ⌋$$

In one example,

$$( the number of SL CSI - RS occasions in a slot ) = ⌊ \frac{{N}_{s} - 7}{( Number of SL CSI - RS symbols in a SL CSI - RS occasion )} ⌋$$

In one example, if there is PSFCH and there is a control region in a slot with either (1) length 2 symbols excluding the duplicate (or AGC) symbol and a gap between the control region and the SL CSI-RS or (2) length 3 symbols excluding the duplicate (or AGC) symbol and no gap between the control region and the SL CSI-RS, the (Number of SL CSI-RS symbols in a SL CSI-RS occasion)×(the number of SL CSI-RS occasions in a slot) is less than or equal to Nₛ−8, with a gap symbol between SL CSI-RS and PSFCH. In one example, the number of symbols per SL CSI-RS occasion can be different, the sum symbols across all SL CSI-RS occasions is less than or equal to Nₛ−8. In one example,

$$( Number of SL CSI - RS symbols in a SL CSI - RS occasion ) = ⌊ \frac{{N}_{s} - 8}{( the number of SL CSI - RS occasions in a slot )} ⌋$$

In one example,

$$( the number of SL CSI - RS occasions in a slot ) = ⌊ \frac{{N}_{s} - 8}{( Number of SL CSI - RS symbols in a SL CSI - RS occasion )} ⌋$$

In one example, if there is no PSFCH but there is a control region in a slot with length 3 symbols excluding the duplicate (or AGC) symbol and a gap between the control region and the SL CSI-RS, the (Number of SL CSI-RS symbols in a SL CSI-RS occasion)×(the number of SL CSI-RS occasions in a slot) is less than or equal to Nₛ−5, with the gap symbol at the end of the slot being included in the SL CSI-RS occasion. In one example, the number of symbols per SL CSI-RS occasion can be different, the sum symbols across all SL CSI-RS occasions is less than or equal to Nₛ−5. In one example,

$$( Number of SL CSI - RS symbols in a SL CSI - RS occasion ) = ⌊ \frac{{N}_{s} - 5}{( the number of SL CSI - RS occasions in a slot )} ⌋$$

In one example,

$$( the number of SL CSI - RS occasions in a slot ) = ⌊ \frac{{N}_{s} - 5}{( Number of SL CSI - RS symbols in a SL CSI - RS occasion )} ⌋$$

In one example, if there is no PSFCH but there is a control region in a slot with length 3 symbols excluding the duplicate (or AGC) symbol and a gap between the control region and the SL CSI-RS, the (Number of SL CSI-RS symbols in a SL CSI-RS occasion)×(the number of SL CSI-RS occasions in a slot) is less than or equal to Nₛ−6, with a gap symbol at the end of the slot. In one example, the number of symbols per SL CSI-RS occasion can be different, the sum symbols across all SL CSI-RS occasions is less than or equal to Nₛ−6. In one example,

$$( Number of SL CSI - RS symbols in a SL CSI - RS occasion ) = ⌊ \frac{{N}_{s} - 6}{( the number of SL CSI - RS occasions in a slot )} ⌋$$

In one example,

$$( the number of SL CSI - RS occasions in a slot ) = ⌊ \frac{{N}_{s} - 6}{( Number of SL CSI - RS symbols in a SL CSI - RS occasion )} ⌋$$

In one example, if there is PSFCH and there is a control region in a slot with length 3 symbols excluding the duplicate (or AGC) symbol and a gap between the control region and the SL CSI-RS, the (Number of SL CSI-RS symbols in a SL CSI-RS occasion)×(the number of SL CSI-RS occasions in a slot) is less than or equal to Nₛ−8, with the gap symbol between SL CSI-RS and PSFCH being included in the SL CSI-RS occasion. In one example, the number of symbols per SL CSI-RS occasion can be different, the sum symbols across all SL CSI-RS occasions is less than or equal to Nₛ−8. In one example,

$$( Number of SL CSI - RS symbols in a SL CSI - RS occasion ) = ⌊ \frac{{N}_{s} - 8}{( the number of SL CSI - RS occasions in a slot )} ⌋$$

In one example,

$$( the number of SL CSI - RS occasions in a slot ) = ⌊ \frac{{N}_{s} - 8}{( Number of SL CSI - RS symbols in a SL CSI - RS occasion )} ⌋$$

In one example, if there is PSFCH and there is a control region in a slot with length 3 symbols excluding the duplicate (or AGC) symbol and a gap between the control region and the SL CSI-RS, the (Number of SL CSI-RS symbols in a SL CSI-RS occasion)×(the number of SL CSI-RS occasions in a slot) is less than or equal to Nₛ−9, with a gap symbol between SL CSI-RS and PSFCH. In one example, the number of symbols per SL CSI-RS occasion can be different, the sum symbols across all SL CSI-RS occasions is less than or equal to Nₛ−9. In one example,

$$( Number of SL CSI - RS symbols in a SL CSI - RS occasion ) = ⌊ \frac{{N}_{s} - 9}{( the number of SL CSI - RS occasions in a slot )} ⌋$$

In one example,

$$( the number of SL CSI - RS occasions in a slot ) = ⌊ \frac{{N}_{s} - 9}{( Number of SL CSI - RS symbols in a SL CSI - RS occasion )} ⌋$$

In one example, let N_{c} be the number of control symbols in a control region in a slot, without duplicate symbol. Let N_{g1}=1, if there is a gap between the control region and the first SL CSI-RS occasion, else N_{g1}=0. Let Nₚ=3 if there is PSFCH in the slot, else Nₚ=0. Let, N_{g2}=1, is there is gap at the end of the slot after the last SL CSI-RS occasion, or if there is a gap between the last SL CSI-RS occasion and PSFCH, else N_{g2}=0. The (Number of SL CSI-RS symbols in a SL CSI-RS occasion)×(the number of SL CSI-RS occasions in a slot) is less than or equal to Nₛ−N_{c}−1−N_{g1}−Nₚ−N_{g2}. In one example, the number of symbols per SL CSI-RS occasion can be different, the sum symbols across all SL CSI-RS occasions is less than or equal to Nₛ−N_{c}−1−N_{g1}−Nₚ−N_{g2}. In one example,

$$( Number of SL CSI - RS symbols in a SL CSI - RS occasion ) = ⌊ \frac{{N}_{s} - {N}_{c} - 1 - {N}_{g 1} - {N}_{p} - {N}_{g 2}}{( the number of SL CSI - RS occasions in a slot )} ⌋$$

In one example,

$$( the number of SL CSI - RS occasions in a slot ) = ⌊ \frac{{N}_{s} - {N}_{c} - 1 - {N}_{g 1} - {N}_{p} - {N}_{g 2}}{( Number of SL CSI - RS symbols in a SL CSI - RS occasion )} ⌋$$

In one example, let N_{c} be the number of control symbols in a control region in a slot, including a duplicate symbol, if any, and Nₛ, Nₚ, N_{g1}, and N_{g2} are as aforementioned. The (Number of SL CSI-RS symbols in a SL CSI-RS occasion)×(the number of SL CSI-RS occasions in a slot) is less than or equal to Nₛ−N_{c}−N_{g1}−Nₚ−N_{g2}. In one example, the number of symbols per SL CSI-RS occasion can be different, the sum symbols across all SL CSI-RS occasions is less than or equal to Nₛ−N_{c}−N_{g1}−Nₚ−N_{g2}. In one example,

$$( Number of SL CSI - RS symbols in a SL CSI - RS occasion ) = ⌊ \frac{{N}_{s} - {N}_{c} - {N}_{g 1} - {N}_{p} - {N}_{g 2}}{( the number of SL CSI - RS occasions in a slot )} ⌋$$

In one example,

$$( the number of SL CSI - RS occasions in a slot ) = ⌊ \frac{{N}_{s} - {N}_{c} - {N}_{g 1} - {N}_{p} - {N}_{g 2}}{( Number of SL CSI - RS symbols in a SL CSI - RS occasion )} ⌋$$

In one example, length of the SL CSI-RS occasions in a slot might not be equal. In one example, the last SL CSI-RS occasion might include a gap symbol, and the remaining SL CSI-RS occasions might not include a gap symbol, hence shorter than the last SL CSI-RS occasion by a symbol. In one example, the first SL CSI-RS occasion might include a duplicate (or AGC) symbol, and the remaining SL CSI-RS occasions might not include a duplicate (or AGC) symbol, hence shorter than the first SL CSI-RS occasion by a symbol.

In one example, the first SL CSI-RS symbol in a SL CSI-RS transmission occasion or in slot can be signaled or determined. In one example, the first SL CSI-RS symbol, can be relative to the start of a slot used for SL transmission. In one example, the first SL CSI-RS symbol, can be relative to the start of a SL CSI-RS occasion. In one example, the first SL CSI-RS symbol, can be that of the duplicate (or AGC) symbol. In one example, the first SL CSI-RS symbol, can be that of the symbol after the duplicate (or AGC) symbol. In example, the first SL CSI-RS symbol is the first symbol of the SL CSI-RS occasion. In example, the first SL CSI-RS symbol is the second symbol of the SL CSI-RS occasion (e.g., after the duplicate (or AGC) symbol). In one example, the first SL CSI-RS symbol can be pre-configured, and/or configured or updated by RRC signaling from a network and/or RRC signaling over PC5 and/or MAC CE signaling and/or L1 control signaling. In one example the first SL CSI-RS symbol can be specified in the system specifications. In one example, if the first SL CSI-RS symbol is not (pre-)configured, a default value specified in the system specification is used.

In one example, the first SL CSI-RS symbol can be after the control region of the corresponding SL CSI-RS occasion. In one example, the first SL CSI-RS symbol can be after the control region of the corresponding SL CSI-RS occasion and after a gap symbol. In one example, the first SL CSI-RS symbol can be after the control region of the corresponding SL CSI-RS occasion and a duplicate (or AGC) symbol. In one example, the first SL CSI-RS symbol can be after the control region of the corresponding SL CSI-RS occasion and after a gap symbol and after a duplicate (or AGC) symbol. In one example, the length of the control region can be pre-configured, and/or configured or updated by RRC signaling from a network and/or RRC signaling over PC5 and/or MAC CE signaling and/or L1 control signaling. In one example the length of the control region can be specified in the system specifications. In one example, if the length of the control region is not (pre-)configured, a default value specified in the system specification is used. In one example, the length of the control region doesn't include the duplicate (or AGC) symbol of the control region. In one example, the length of the control region includes the duplicate (or AGC) symbol of the control region. In one example, the length of the control region doesn't include a gap symbol between the control region and SL CSI-RS. In one example, the length of the control region includes a gap symbol between the control region and SL CSI-RS. In one example, the length of the control region can be 1 symbol or 2 symbols or 3 symbols. In one example, the length of the control region can be 2 symbols or 3 symbols.

In one example, the following parameters can be pre-configured and/or configured by higher layer signaling: N_{f}, the first SL CSI-RS symbol in a slot, and Nᵣ number of times the SL CSI-RS symbol is repeated. In a variant example, Nᵣ is the number of symbols between one SL CSI-RS transmission and the next. In one example, first symbol of SL CSI-RS transmissions in a slot can N(m)=N_{f}+m*Nᵣ, where m=0,1, . . . M−1, wherein M is the number of SL CSI-RS transmissions in a slot. In one example, M can be pre-configured, and/or configured or updated by RRC signaling from a network and/or RRC signaling over PC5 and/or MAC CE signaling and/or L1 control signaling. In one example M can be specified in the system specifications. In one example, if M is not (pre-)configured, a default value specified in the system specification is used. In one example, M is calculated to use the available symbols in a slot for SL CSI-RS transmissions.

In further example, N_{g}=1 is there is a gap symbol between SL CSI-RS transmissions, and it is not included in Nᵣ else N_{g}=0. In one example, N_{d}=1 is there is a duplicate (or AGC) symbol between SL CSI-RS transmissions, and it is not included in Nᵣ else N_{d}=0. In one example, Nₑ is the number of control symbols preceding a SL CSI-RS transmission if any include any duplicate or gap symbols associated with the control symbols, else N_{c}=0. In one example, first symbol of SL CSI-RS transmissions in a slot can N(m)=N_{f}+m*(Nᵣ+N_{g}+N_{d}+N) where, m=0, 1, . . . M−1, wherein M is the number of SL CSI-RS transmissions in a slot.

In one example, N(m) is the first symbol of SL CSI-RS after duplicate symbol. In one example, N(m) is the first symbol of SL CSI-RS including the duplicate symbol if present.

In one example, the control region can include multiple PSCCHs. In one example, there is a mapping between the PSCCH, and the resource used for SL CSI-RS. Wherein the resource for SL CSI-RS can be determined based on one or more the following:
The time domain location within a slot (e.g., based on the SL CSI-RS occasion used). In one example, N_{T} is the number of SL CSI-RS occasions (time occasions) in a slot. In one example, the location of PSCCH can determine (e.g., based on mapping) which SL CSI-RS occasion (time occasion) to use. In one example, each SL CSI-RS occasion (time occasion) has its control region, and hence this determines the mapping between PSCCH and the SL CSI-RS occasion (time occasion).
The starting PRB or sub-channel of the SL CSI-RS. In one example N_{F} is the number of starting PRBs or sub-channels for SL CSI-RS, e.g., number of SL CSI-RS frequency occasions. The number of PRBs or sub-channels allocated SL CSI-RS is N_{F,size}. In one example, N_{F,size} can be pre-configured, and/or configured or updated by RRC signaling from a network and/or RRC signaling over PC5 and/or MAC CE signaling and/or L1 control signaling. In one example N_{F,size} can be specified in the system specifications. In one example, if N_{F,size} is not (pre-)configured, a default value specified in the system specification is used. In one example, N_{F,size} can correspond to the entire SL BPW size. In one example, the location of PSCCH can determine (e.g., based on mapping) which SL CSI-RS frequency occasion to use as described later in this disclosure. In example. PSCCH with a frequency region or occasion correspond to the SL CSI-RS with that frequency occasion, as described later in this disclosure.
The sub-carrier location for SL CSI-RS, for example, this can be also based on the density and the number of antenna ports. N_{R} is the number of SL CSI-RS in one Time/Frequency CSI-RS occasion:
   In one example, if the density ρ=1 and number of antenna ports is 1, there can be 12 possible starting sub-carrier location for each PRB allocated to SL CSI-RS, i.e., N_{R}=12. The location of PSCCH can determine (e.g., based on mapping) which sub-carrier within the PRBs to use.
   In one example, if the density ρ=1 and number of antenna ports is 2, there can be 6 possible starting sub-carrier locations for each PRB allocated to SL CSI-RS, i.e., N_{R}=6. The location of PSCCH can determine (e.g., based on mapping) which sub-carriers within the PRBs use.
   In one example, if the density ρ=0.5 and number of antenna ports is 1, there can be 24 possible starting sub-carrier location for each pair of PRBs allocated to SL CSI-RS, i.e., N_{R}=24. The location of PSCCH can determine (e.g., based on mapping) which PRBs (even or odd) and which sub-carrier within those PRBs to use.
   In one example, if the density ρ=0.5 and number of antenna ports is 2, there can be 12 possible starting sub-carrier location for each pair of PRBs allocated to SL CSI-RS, i.e., N_{R}=12. The location of PSCCH can determine (e.g., based on mapping) which PRBs (even or odd) and which sub-carriers within those PRBs to use.
   In one example, if the density ρ=3 and number of antenna ports is 1, there can be 4 possible starting sub-carrier location for each PRB allocated to SL CSI-RS, i.e., N_{R}=4. The location of PSCCH can determine (e.g., based on mapping) which sub-carrier within the PRBs to use. Three REs in the PRB can be used that can be contiguous or separated by 4 REs.
   In one example, if the density ρ=3 and number of antenna ports is 2, there can be 2 possible starting sub-carrier locations for each PRB allocated to SL CSI-RS, i.e., N_{R}=2. The location of PSCCH can determine (e.g., based on mapping) which sub-carriers within the PRBs use. Three pairs of REs in the PRB can be used that can be contiguous or separated by 4 REs

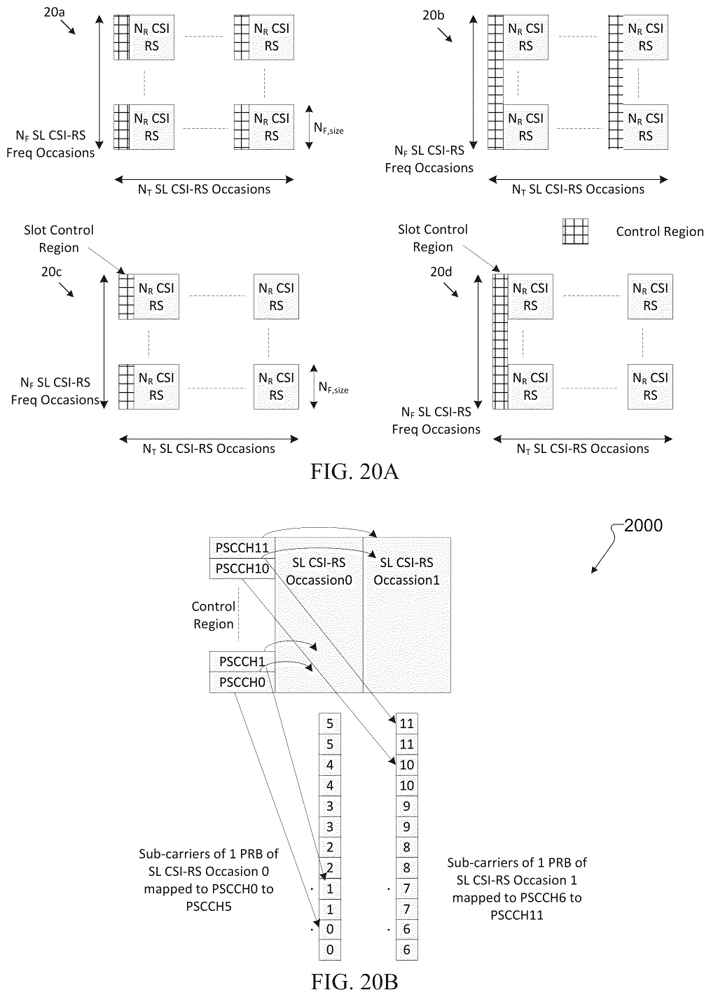

FIG. 20A illustrates examples of allocations of SL CSI-RS in a slot according to embodiments of the present disclosure. For example, the allocations can be utilized by one or more of the UEs 111-111C of FIG. 1. This example is for illustration only and other embodiments can be used without departing from the scope of the present disclosure.

In allocation 20a, each SL CSI-RS occasion (time occasion) has its control channels, the control channel within each frequency region (of size N_{F,size}) are associated to the SL CSI-RS resources of that frequency region. Therefore, the control occasions (e.g., PSCCH occasions or PSCCH/PSSCH occasions) of each SL CSI-RS Time/Frequency Occasion is mapped or associated with SL CSI-RS resources within that SL CSI-RS Time/Frequency occasion (e.g., N_{R} resources).

In allocation 20b, each SL CSI-RS occasion (time occasion) has its control channels, the control channel across all frequency regions (of size N_{F,size}) can be associated to the SL CSI-RS resources of any frequency region. Therefore, the control occasions (e.g., PSCCH occasions or PSCCH/PSSCH occasions) of each SL CSI-RS Occasion (time occasion) are mapped or associated with SL CSI-RS resources within that SL CSI-RS occasion (time occasion) (e.g., N_{F}×N_{R} resources). The mapping order can be starting with the smallest frequency (or time) index control occasion (e.g., PSCCH occasions or PSCCH/PSSCH occasions), first map to N_{R} resources of one SL CSI-RS Time/Frequency Occasion, then map across the N_{F} CSI-RS Frequency occasions. Alternatively, map across N_{F} then N_{R}.

In allocation 20c, all SL CSI-RS occasion (time occasion) have common (e.g., shared) control channels, the control channel within each frequency region (of size N_{F,size}) are associated to the SL CSI-RS resources of that frequency region. Therefore, the control occasions (e.g., PSCCH occasions or PSCCH/PSSCH occasions) of each SL CSI-RS frequency Occasion across the slot are mapped or associated with SL CSI-RS resources within that SL CSI-RS frequency occasion (e.g., N_{T}×N_{R} resources). The mapping order can be starting with the smallest frequency (or time) index control occasion (e.g., PSCCH occasions or PSCCH/PSSCH occasions), first map to N_{R} resources of one SL CSI-RS Time/Frequency Occasion, then map across the N_{T} CSI-RS occasions (Time occasions). Alternatively, map across N_{T} then N_{R}.

In allocation 20d, all SL CSI-RS occasion (time occasion) have common (e.g., shared) control channels, the control channel across all frequency regions (of size N_{F,size}) can be associated to the SL CSI-RS resources of any frequency region. Therefore, the control occasions (e.g., PSCCH occasions or PSCCH/PSSCH occasions) of a slot are mapped or associated with SL CSI-RS resources within slot (e.g., N_{T}×N_{F}×N_{R} resources). The mapping order can be starting with the smallest frequency (or time) index control occasion (e.g., PSCCH occasions or PSCCH/PSSCH occasions), first map to N_{R} resources of one SL CSI-RS Time/Frequency Occasion, then map across the N_{F} CSI-RS Frequency occasions, then map across the N_{T} CSI-RS occasions (Time occasions). Alternatively, first map to N_{R} resources of one SL CSI-RS Time/Frequency Occasion, then map across the N_{T} CSI-RS occasions (Time occasions), then map across the N_{F} CSI-RS Frequency occasions. Alternatively, map across N_{F} then N_{R} then N_{T}. Alternatively, map across N_{T} then N_{R} then N_{F}. Alternatively, map across N_{F} then N_{T} then N_{R}. Alternatively, map across N_{T} then N_{T} then N_{R}.

FIG. 20B illustrates an example of PSCCH to SL CSI-RS occasion mappings 2000 according to embodiments of the present disclosure. For example, the mappings 2000 can be utilized by one or more of the UEs 111-111C of FIG. 1. This example is for illustration only and other embodiments can be used without departing from the scope of the present disclosure.

As illustrated in FIG. 20B, the control region of a slot has 12 PSCCH occasions, the example shows PSCCH multiplexed in frequency domain, for example each PSCCH can be allocated one or more sub-channels or each PSCCH can be allocated one or more PRBs. In one example, the number of sub-channels or PRBs for PSCCH can be pre-configured, and/or configured or updated by RRC signaling from a network and/or RRC signaling over PC5 and/or MAC CE signaling and/or L1 control signaling. In one example the number of sub-channels or PRBs for PSCCH can be specified in the system specifications. In one example, if the number of sub-channels or PRBs for PSCCH is not (pre-)configured, a default value specified in the system specification is used. In one example, the number of sub-channels or PRBs for PSCCH is for a resource pool. While showing multiplexing for PSCCH in frequency domain, the multiplexing can also be done in the time domain, e.g., a first set of symbols is allocated to a first PSCCH and a second set of symbols is allocated to a second PSCCH. In the example of FIG. 20B, the slot has two SL CSI-RS occasions (time occasions). The density of CSI-RS is 1 with 2 antenna ports. Therefore, each CSI-RS occasion can multiplex 6 users (each user on a pair of sub-carriers within a PRB)—N_{R}=6. In this example the PSCCHs are mapped such that PSCCH 0 to PSCCH 5 are mapped to the first SL CSI-RS occasion as illustrated. And PSCCH 6 to PSCCH 11 are mapped to the second SL CSI-RS occasion as illustrated.

In one example, the mapping order of PSCCHs (e.g., starting with the PSCCH that has the smallest frequency index) to SL CSI-RS can be first in order of sub-carriers within a PRB, then in order of PRBs (even followed by odd or odd followed by even) then in order of SL CSI-RS occasions.

In one example, the mapping order of PSCCHs to SL CSI-RS can be first in order in order of PRBs (even followed by odd or odd followed by even), then of in order of sub-carriers within a PRB, then in order of SL CSI-RS occasions.

In another example, the mapping order can be first in order of SL CSI-RS occasions followed by sub-carrier and then PRBs.

In another example, the mapping order can be first in order of SL CSI-RS occasions followed by PRBs and then sub-carriers.

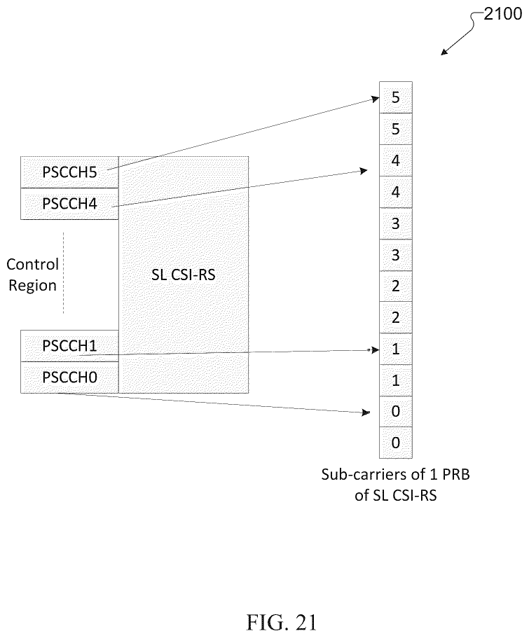

FIG. 21 illustrates an additional example of PSCCH to SL CSI-RS occasion mappings 2100 according to embodiments of the present disclosure. For example, the mappings 2100 can be utilized by one or more of the UEs 111-111C of FIG. 1. This example is for illustration only and other embodiments can be used without departing from the scope of the present disclosure.

As illustrated in FIG. 21, the control region of a SL CSI-RS resource has 6 PSCCH occasions, the example shows PSCCH multiplexed in frequency domain, for example each PSCCH can be allocated one or more sub-channels or each PSCCH can be allocated one or more PRBs. In a variant example, the multiplexing can be additionally or alternatively in time domain. In one example, the number of sub-channels or PRBs for PSCCH can be pre-configured, and/or configured or updated by RRC signaling from a network and/or RRC signaling over PC5 and/or MAC CE signaling and/or L1 control signaling. In one example the number of sub-channels or PRBs for PSCCH can be specified in the system specifications. In one example, if the number of sub-channels or PRBs for PSCCH is not (pre-)configured, a default value specified in the system specification is used. In one example, the number of sub-channels or PRBs for PSCCH is for a resource pool. While showing multiplexing in frequency domain, the multiplexing can also be done in the time domain. In the example of FIG. 21, the density of CSI-RS is 1 with 2 antenna ports. Therefore, each CSI-RS can multiplex 6 users (each user on a pair of sub-carriers within a PRB)—NR=6.

In one example, the mapping order of PSCCHs to SL CSI-RS can be first in order of sub-carriers within a PRB, then in order of PRBs (even followed by odd or odd followed by even).

In one example, the mapping order of PSCCHs to SL CSI-RS can be first in order in order of PRBs (even followed by odd or odd followed by even), then of in order of sub-carriers within a PRB.

In one example, the control region can include multiple PSCCHs.
If the control region is for a slot, the control information in the PSCCH can indicate which SL CSI-RS occasion it is associated with.
In one example, the PSCCHs of a frequency region are mapped or associated to the SL CSI-RS resources of that frequency region. In one example, the PSCCHs of a frequency region are mapped or associated to the SL CSI-RS resources of any frequency region, control information can indicate the frequency region of the SL CSI-RS resource.
The control information in PSCCH can indicate which sub-carriers are used for the resource.
The control information in PSCCH can indicate whether the even PRB or the odd PRB is used, when ρ=0.5.

In one example, PSCCH occasions in a control region are multiplexed in frequency. The order of mapping of PSCCH occasions to SL CSI-RS resources can be in order frequency starting with the lowest PSCCH frequency.

In one example, PSCCH occasions in a control region are multiplexed in frequency and in time. The order of mapping of PSCCH occasions to SL CSI-RS resources can be in order of frequency followed by time starting with the lowest PSCCH frequency, and the lowest symbol number for PSCCH,

In one example, PSCCH occasions in a control region are multiplexed in frequency and in time. The order of mapping of PSCCH occasions to SL CSI-RS resources can be in order of time followed by frequency starting with the lowest symbol number for PSCCH and the lowest PSCCH frequency,

While in various examples, the channel in the control is shown as PSCCH. It can also be PSSCH or PSCCH and PSSCH. Where, the PSCCH includes a first stage SCI and the PSSCH includes a second stage SCI.

In one example, a SL CSI-RS resource set can be configured, which includes more than one SL CSI-RS resource. In one example, a SL CSI-RS resource is transmitted with a same beam in different SL slots or in different SL CSI-RS occasions (e.g., time occasions).

In one example, a user can transmit SL CSI-RS using different beams or different spatial domain transmission filters in different SL CSI-RS occasions (e.g., time occasions) in the same slot.

In one example, a user can transmit SL CSI-RS using a same beam or a same spatial domain transmission filter in different SL CSI-RS occasions (e.g., time occasions) in the same slot.

In one example, a user can transmit SL CSI-RS using a same beam or a same spatial domain transmission filter for symbols of a SL CSI-RS occasion (e.g., time occasion).

In one example, a user can transmit SL CSI-RS using different beams or different spatial domain transmission filters for different symbols of a SL CSI-RS occasion (e.g., time occasion).

In one example, a user can transmit SL CSI-RS using different beams or different spatial domain transmission filters for different symbols of a SL slot.

In one example, a UE receiving the SL CSI-RS can request the UE transmitting SL CSI-RS to transmit one or more SL CSI-RS resources, e.g., SL CSI-RS resources corresponding to a spatial domain transmission filter.

In one example SL CSI-RS resource is configured, the beam used for the SL CSI-RS resource can depend on the slot number and/or the SL CSI-RS occasion (e.g., time occasion) number for example based on mapping that uses the modulo operator. For example, SL CSI-RS resources are numbered sequentially, the SL CSI-RS resource number modulo % N determines the beam or spatial filter to use. In one example, N can be pre-configured, and/or configured or updated by RRC signaling from a network and/or RRC signaling over PC5 and/or MAC CE signaling and/or L1 control signaling. In one example N can be specified in the system specifications. In one example, if N is not (pre-)configured, a default value specified in the system specification is used. In one example, a slot is a logical slot of a SL resource pool. In one example, a slot is a physical slot. In one example, the ordering of resources can be across N_{T} and slots. In one example, the ordering of resources can be across N_{F}, N_{T} and slots. In one example, the ordering of resources can be across N_{T} and slots. In one example, the ordering of resources can be across N_{R}, N_{T} and slots. In one example, the ordering of resources can be across N_{T} and slots. In one example, the ordering of resources can be across N_{R}, N_{F}, N_{T} and slots. In one example, the ordering of resources can be across slots.

In one example, the control information can indicate the SL CSI-RS. In one example, the SL CSI-RS can determine which sub-carriers to use and whether the even PRB or the odd PRB are used when ρ=0.5.

In one example, the number of PRBs or sub-channels (e.g., N_{F,size}) for SL CSI-RS can be pre-configured, and/or configured or updated by RRC signaling from a network and/or RRC signaling over PC5 and/or MAC CE signaling and/or L1 control signaling. In one example the number of PRBs or sub-channels for SL CSI-RS can be specified in the system specifications. In one example, if the number of PRBs or sub-channels for SL CSI-RS is not (pre-)configured, a default value specified in the system specification is used. In one example, a slot a logical slot of a SL resource pool. In one example, a slot a physical slot.

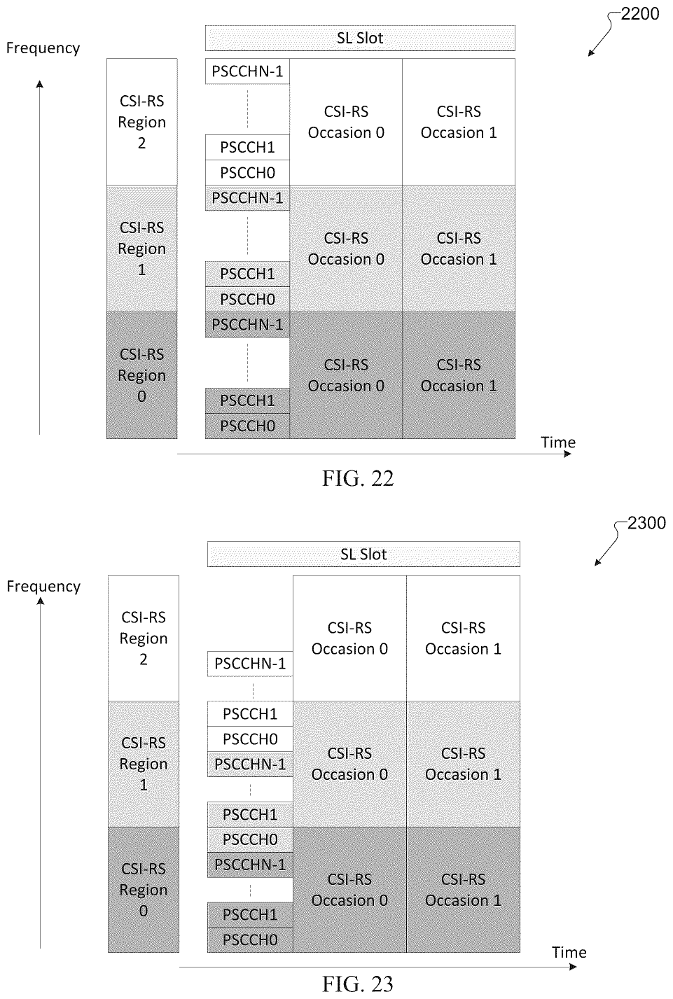

FIGS. 22-23 illustrate examples of frequency regions for SL CSI-RS transmission 2200 and 2300 in a SL slot according to embodiments of the present disclosure. For example, the frequency regions for SL CSI-RS transmission 2200 and 2300 can be utilized by one or more of the UEs 111-111C of FIG. 1. This example is for illustration only and other embodiments can be used without departing from the scope of the present disclosure.

In one example, there can be multiple frequency regions for SL CSI-RS transmission as illustrated in FIG. 22. In one example, control channels associated with SL CSI-RS transmitted in a region correspond to a SL CSI-RS resources transmitted in that region.

While FIG. 22 is shown for a control region of a slot, this can also apply to a control region of a SL CSI-RS occasion.

In one example, there can be multiple frequency regions for SL CSI-RS transmission as illustrated in FIG. 23. In one example, control channels associated with SL CSI-RS transmitted in a region correspond to a SL CSI-RS resources transmitted in any region.

While FIG. 23 is shown for a control region of a slot, this can also apply to a control region of a SL CSI-RS occasion.

In one example, the SL CSI-RS according to the examples of this disclosure can be used for initial beam acquisitioning, before, after or during link establishment. In one example, the SL CSI-RS according to the examples of this disclosure can be used for beam maintenance and beam refinement.

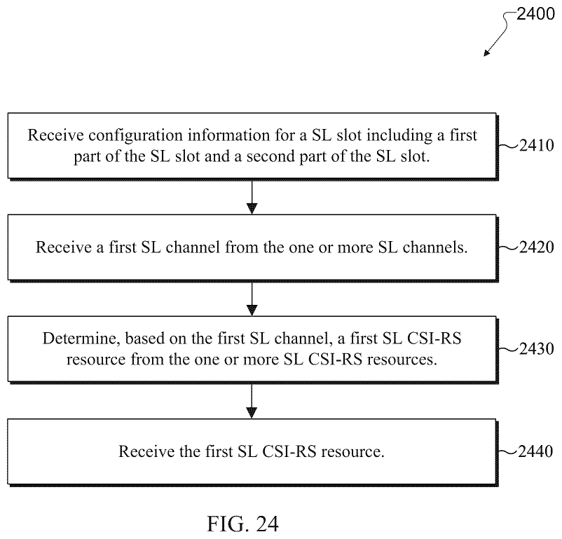

FIG. 24 illustrates a flowchart of an example UE procedure 2400 for SL CSI-RS signaling according to embodiments of the present disclosure. For example, procedure 2400 for SL CSI-RS signaling can be performed by the UE 111 and UE 111A of FIG. 1. This example is for illustration only and other embodiments can be used without departing from the scope of the present disclosure.

The procedure begins in 2410, with the UE receiving configuration information for a SL slot that includes a first part of the SL slot and a second part of the SL slot. For example, in 2410, the first part includes one or more SL channels and the second part includes one or more SL CSI-RS resources.

In various embodiments, the SL slot includes more than one occasion, an occasion from the more than one occasion includes N symbols, where N>=1, each occasion of the more than one occasion includes the first part and the second part, and a SL channel in the first part of the occasion indicates a SL CSI-RS in the second part of the occasion.

The UE then receives a first SL channel from the one or more SL channels (2420). In various embodiments, the configuration information includes an association between the first SL channel and the first SL CSI-RS resource. In various embodiments, the first SL channel is a PSCCH. In various embodiments, the first SL channel is a PSSCH.

In various embodiments, the first SL channel includes information indicating at least one of symbols used for the first SL CSI-RS resource, sub-channels used for the first SL CSI-RS resource, where a sub-channel from the sub-channels is one or more PRBs, sub-carriers within the one or more PRBs used for the first SL CSI-RS resource, and whether the one or more PRBs used for the first SL CSI-RS resource are even or odd.

The UE then determines, based on the first SL channel, a first SL CSI-RS resource from the one or more SL CSI-RS resources (2430). In various embodiments, the first SL channel includes information indicating more than one SL CSI-RS resource. The UE then receives the first SL CSI-RS resource (2440).

In various embodiments, the UE transmits a second SL CSI-RS resource from the one or more SL CSI-RS resources and a second SL channel from the one or more SL channels, where the second SL channel is associated with the second SL CSI-RS resource. In various embodiments, the second SL channel and the second SL CSI-RS resource use a same spatial domain transmission filter. In various embodiments, the UE transmits more than one CSI-RS resources from the one or more SL CSI-RS resources and a second SL channel from the one or more SL channels, where the second SL channel is associated with the more than one CSI-RS resources.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive:
configuration information for a sidelink (SL) slot, the SL slot including a first part of the SL slot and a second part of the SL slot, wherein the first part includes one or more SL channels and wherein the second part includes one or more SL channel state information reference signal (CSI-RS) resources, and
a first SL channel from the one or more SL channels; and
a processor operably coupled to the transceiver, the processor configured to determine, based on the first SL channel, a first SL CSI-RS resource from the one or more SL CSI-RS resources,
wherein the transceiver is further configured to receive the first SL CSI-RS resource.

2. The UE of claim 1, wherein the configuration information includes an association between the first SL channel and the first SL CSI-RS resource.

3. The UE of claim 1, wherein the first SL channel is a physical sidelink control channel (PSCCH).

4. The UE of claim 1, wherein the first SL channel is a physical sidelink shared channel (PSSCH).

5. The UE of claim 1, wherein the first SL channel includes information indicating at least one of:
symbols used for the first SL CSI-RS resource,
sub-channels used for the first SL CSI-RS resource, wherein a sub-channel from the sub-channels is one or more physical resource blocks (PRBs),
sub-carriers within the one or more PRBs used for the first SL CSI-RS resource, and
whether the one or more PRBs used for the first SL CSI-RS resource are even or odd.

6. The UE of claim 1, wherein the first SL channel includes information indicating more than one SL CSI-RS resource.

7. The UE of claim 1, wherein:
the SL slot includes more than one occasion,
an occasion from the more than one occasion includes N symbols, where N>=1,
each occasion of the more than one occasion includes the first part and the second part, and
a SL channel in the first part of the occasion indicates a SL CSI-RS in the second part of the occasion.

8. The UE of claim 1, wherein:
the transceiver is further configured to transmit:
a second SL CSI-RS resource from the one or more SL CSI-RS resources, and
a second SL channel from the one or more SL channels,
the second SL channel is associated with the second SL CSI-RS resource.

9. The UE of claim 8, wherein the second SL channel and the second SL CSI-RS resource use a same spatial domain transmission filter.

10. The UE of claim 1, wherein:
the transceiver is further configuration to transmit:
more than one CSI-RS resources from the one or more SL CSI-RS resources, and
a second SL channel from the one or more SL channels,
the second SL channel is associated with the more than one CSI-RS resources.

11. A method of operating a user equipment (UE), the method comprising:
receiving configuration information for a sidelink (SL) slot, the SL slot including a first part of the SL slot and a second part of the SL slot, wherein the first part includes one or more SL channels and wherein the second part includes one or more SL channel state information reference signal (CSI-RS) resources;
receiving a first SL channel from the one or more SL channels;
determining, based on the first SL channel, a first SL CSI-RS resource from the one or more SL CSI-RS resources; and
receiving the first SL CSI-RS resource.

12. The method of claim 11, wherein the configuration information includes an association between the first SL channel and the first SL CSI-RS resource.

13. The method of claim 11, wherein the first SL channel is a physical sidelink control channel (PSCCH).

14. The method of claim 11, wherein the first SL channel is a physical sidelink shared channel (PSSCH).

15. The method of claim 11, wherein the first SL channel includes information indicating at least one of:
symbols used for the first SL CSI-RS resource,
sub-channels used for the first SL CSI-RS resource, wherein a sub-channel from the sub-channels is one or more physical resource blocks (PRBs),
sub-carriers within the one or more PRBs used for the first SL CSI-RS resource, and
whether the one or more PRBs used for the first SL CSI-RS resource are even or odd.

16. The method of claim 11, wherein: the first SL channel includes information indicating more than one SL CSI-RS resource.

17. The method of claim 11, wherein:
the SL slot includes more than one occasion,
an occasion from the more than one occasion includes N symbols, where N>=1,
each occasion of the more than one occasion includes the first part and the second part, and
a SL channel in the first part of the occasion indicates a SL CSI-RS in the second part of the occasion.

18. The method of claim 11, further comprising transmitting:
a second SL CSI-RS resource from the one or more SL CSI-RS resources; and
a second SL channel from the one or more SL channels, wherein the second SL channel is associated with the second SL CSI-RS resource.

19. The method of claim 18, wherein the second SL channel and the second SL CSI-RS resource use a same spatial domain transmission filter.

20. The method of claim 11, further comprising transmitting:
more than one CSI-RS resources from the one or more SL CSI-RS resources; and
a second SL channel from the one or more SL channels,
wherein the second SL channel is associated with the more than one CSI-RS resources.
